(19) United States
(12) Patent Application Publication
(10) Pub. No.: US 2016/0253458 A1
(43) Pub. Date: Sep. 1, 2016

(54) Methods, Devices, and Systems Having Multiple Passwords

(71) Applicant: Theranos, Inc., Palo Alto, CA (US)

(72) Inventor: Ramesh Balwani, Palo Alto, CA (US)

(21) Appl. No.: 15/054,966

(22) Filed: Feb. 26, 2016

Related U.S. Application Data
(63) Continuation of application No. PCT/US14/55687, filed on Sep. 15, 2014.
(60) Provisional application No. 61/877,560, filed on Sep. 13, 2013.

(51) Int. Cl. G06F 19/00; G06F 21/62; H04L 29/06

(52) U.S. Cl. CPC G06F 19/322; H04L 63/105; H04L 63/083; G06F 21/6245

(57) ABSTRACT

Password-protected methods, systems, and devices are disclosed in which a first password provides access to a first (limited) level, and a second password provides access to a second level, where the second level provides an operation, communication, or information not available at the first level. A system or device may include a processor (e.g., a computer, telephone, tablet, or other device). In embodiments, activities using the second level may include activities available at the first level. The existence of the second level is not detectable at the first level, nor are the operation, communication, or information not available at the first level detectable at the second level. A first-level password may be shared with family or friends while maintaining exclusivity and confidentiality for information and operations available at the second level. Further passwords, associated with further levels, may be provided.

### BACKGROUND

Many devices and systems require users to enter a password and for that password to be verified prior to allowing access to, or operation of, the device or system. Some devices and systems require an identifier, which is typically linked to a password, prior to allowing access to, or operation of, the device or system. In some cases, a device or system may be configured for use by multiple users, each of which users has a unique identifier and password. Different users (i.e., different identifier and password pairs) may be afforded different levels of access to, or operation of, devices or systems.

Current techniques have limitations, including limitations related to unauthorized or inappropriate use of a device or system due to discovery of a password, or loss of a password, or other situation. Accordingly, improved methods for controlling access to, and operation of, password-protected devices and systems are needed.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### SUMMARY

Applicants disclose methods, systems, and devices whose operations, uses, and control are password-protected operations, uses, and controls, in which a user providing a first password gains access to a first (e.g., basic) level, and in which that same user, providing a second password gains access to a second (e.g., hidden) level. Thus, two passwords are associated with a single identified user; one or the other of those passwords associated with the identified user must be provided by the identified user in order to gain access to the systems or devices, or to practice the methods. Those providing the first password only are given access to the first level but not the second; the existence of the second level is not detectable from the first level. The second (e.g., hidden) level is detectable to, and accessible to, only those who provide the second password; the second level is not detectable, and not accessible, to anyone who has provided a first password. In embodiments, three passwords, or four passwords, or more, are associated with a single identified user, each password providing a different level of access or allowing different uses.

In embodiments, an identified user may be a patient, and methods, systems, and devices may be related to clinical history, test results, prescriptions, and other health-related and medical-related information. In embodiments, an identified user may be provided with access to medical-related and health-related records, including lab reports. Such lab-reports may include, without limitation, lab-reports for a test selected from pregnancy, an infectious disease, a genetic disease or condition, a sexually-transmitted disease, a degenerative disease, a dementing disease or condition, a malignant disease or condition, an autoimmune disease or condition, a chronic disease or condition, an acute disease or condition, an injury, a childhood disease, and an adult-onset disease. In embodiments, the results of a first test or a first group of tests may be provided to an identified user upon entry of a first password, and the results of a second test or a second group of tests (which, in embodiments, may include some or all of the first group) may be provided to an identified user upon entry of a second password. For example, an identified user using a first password may be provided the results of a test for one or more of an autoimmune disease or condition, a chronic disease or condition, an acute disease or condition, an injury, a childhood disease, and an adult-onset disease; and the same identified user using a second password may be provided the results of a results of a test for one or more of pregnancy, an infectious disease, a genetic disease or condition, a sexually-transmitted disease, a degenerative disease, a dementing disease or condition, and a malignant disease or condition. Such dual-password methods, devices, and systems may provide users with confidentiality and may help maintain user privacy.

Thus, methods, devices, and systems are provided in which the particular password, of two or more passwords, determines the level of access, operation, and information available to a user of the methods, devices, and systems. In embodiments, the methods, devices, and systems may be used by entering the password. A user willing to share a password with family, friends, or co-workers may thus provide others with a first password, allowing others access to information and operations at the first level, while maintaining exclusivity and confidentiality for information and operations available at the second level. In embodiments, a user is first identified, and then a password is entered in order to use the methods, devices, and systems. A user willing to share a username (or other user identification) and a password with family, friends, or co-workers may thus provide others with a first password, allowing others access to information and operations at the first level, while maintaining exclusivity and confidentiality for information and operations available at the second level. In embodiments, a third level may be accessed by use of a third password (in embodiments, by use of a third password associated with a particular identified user); and in further embodiments, a fourth, fifth, and so forth level may be accessed by use of a fourth, fifth, and so forth password (in embodiments, by use of a fourth, fifth, and so forth password associated with a particular identified user)

Applicants disclose methods, devices and systems comprising a processor configured to operate with a plurality of passwords for a single identified user, wherein a first password provides access to a first level of information, communication, and/or operations, and a second password provides a second level of information, communication, and/or operations. In embodiments, the first password provides only a first level of information, communication, and/or operations, and does not allow knowledge of or access to the second level; and the second password provides a second level of information, communication, and/or operations, visible or accessible from the second level. In embodiments, the second level of information, communication, and/or operations may comprise information, communication, and/or operations that are distinct from the information, communication, and/or operations of the first level. In embodiments, the second level of information, communication, and/or operations may include some or all of the information, communication, and/or operations accessible at the first level. In embodiments, the second level of information, communication, and/or operations may include all of the information, communication, and/or operations accessible at the first level. In embodiments, the first password provides only a first level of information, communication, and/or operations, and does not allow knowledge of or access to the second level; the second password provides both a first and a second level of information, communication, and/or operations, both of which are visible or accessible from the second level.

Similarly, password-protected operations, uses, and controls are provided in which a user providing a first password gains access to a first (e.g., basic) level, and in which that same user, providing a second password gains access to a second (e.g., hidden) level, and in which that same user, providing a third password gains access to a second (e.g., deeper) level. The second and third levels are not detectable to a user providing a first password (which provides only access to the first level). The third level is not detectable to, nor accessible by, a user providing a first password (which provides only access to the first level) or to a user providing a second password (which provides only access to the first and second levels). A user willing to share a password with family, friends, or co-workers may thus provide others with a first password, allowing others access to information and operations at the first level, while maintaining exclusivity and confidentiality for information and operations available at the second level and at the third; and may provide others with a second password, allowing others access to information and operations at the second level, while still maintaining exclusivity and confidentiality for information and operations available at the third level.

In embodiments, further passwords and levels may also be provided. Knowledge of the existence of higher levels, and access to higher levels, is denied to users providing a password for a lower level.

Accordingly, Applicants disclose methods of providing password-protected access to a system or device comprising a processor, where a user is an identified user, the method comprising providing a first password and a second password associated with said identified user, wherein said first password provides a first level of access to said system or device, and said second password provides a second level of access to said system or device; wherein said second level of access includes access to information, communication, and/or operations unavailable at said first level of access; wherein said second level of access includes access to information, communication, and/or operations unavailable at said first level of access, and wherein a user with access to said first level only is not aware of the existence of said information, communication, and/or operations available at said second level but unavailable at said first level of access; and wherein no indication of the existence of the second level, or of information, files, programs, utilities, hardware, or other capabilities unique to the second level is available or visible to a first level user.

In embodiments, access to information, communication, and/or operations may include, without limitation, cell-phone access, internet access, Wi-Fi access, access to an application (e.g., a cellphone “app”), access to an operation, access to a file, access to a database, access to a message, access to a document, access to a lab-report, access to a medical record, access to a photograph, access to an activity log, access to a bank account, access to a brokerage account, access to a financial record, access to a bill, access to a location tracking device, and access to other information, communications, and operations. In embodiments, a message may include, without limitation, an email message, a voicemail message, a real-time message, a stored message, and other messages. In embodiments, a lab-report may include, without limitation, a lab-report for a test selected from pregnancy, an infectious disease, a genetic disease or condition, a sexually-transmitted disease, a degenerative disease, a dementing disease or condition, a malignant disease or condition, an autoimmune disease or condition, a chronic disease or condition, an acute disease or condition, an injury, a childhood disease, and an adult-onset disease.

In embodiments, a system or a device having two, three, or more levels of password-protection for a single user (e.g., associated with a single username, or identification number, identification card, or other identifier) may include, without limitation, a computer, a cell-phone, a tablet computer, a dedicated link to a central database, a dedicated link to a sample analysis device, a dedicated link to an automated sample analysis device, a sample analysis device, an automated sample analysis device, or other device comprising a processor.

In embodiments, both the first level and the second level of operation are visible or accessible from the second level of operation. In embodiments comprising a third password and a third level of operation, the first, said second, and third level of operation may be visible or accessible from the third level of operation; and only the first and second levels may be visible or accessible from the second level of operation; and only the first level of operation may be visible or accessible from the first level of operation. In embodiments comprising a fourth password and a fourth level of operation, the first, second, third, and fourth level of operation may be visible or accessible from the fourth level of operation; and only the first, second, and third level of operation may be visible or accessible from the third level of operation; and only the first and second level of operation are visible or accessible from the second level; and only the first level of operation is visible or accessible from the first level of operation.

Applicants further disclose devices comprising a processor configured to operate with a plurality of passwords for a single identified user, wherein a first password provides access to a first level of information, communication, and/or operations, and a second password provides a second level of information, communication, and/or operations, wherein said first and said second level of information, communication, and/or operations are visible or accessible from the second level; and wherein only said first level of information, communication, and/or operations is visible or accessible from the first level. Such devices may comprise a computer, a cell-phone, a tablet computer, a dedicated link to a central database, a dedicated link to a sample analysis device, a dedicated link to an automated sample analysis device, a sample analysis device, or an automated sample analysis device. In embodiments, such devices may provide access to information, communication, and/or operations which comprises one or more of cell-phone access, internet access, Wi-Fi access, access to an application (e.g., a cellphone “app”), access to an operation, access to a file, access to a database, access to a message, access to a document, access to a lab-report, access to a medical record, access to a photograph, access to an activity log, access to a bank account, access to a brokerage account, access to a financial record, access to a bill, access to a location tracking device, and access to other information, communications, and operations

In embodiments, such messages may be selected from an email message, a voicemail message, a real-time message, a stored message, and other messages. In embodiments, such a lab-report may be a lab-report for a test selected from pregnancy, an infectious disease, a genetic disease or condition, a sexually-transmitted disease, a degenerative disease, a dementing disease or condition, a malignant disease or condition, an autoimmune disease or condition, a chronic disease or condition, an acute disease or condition, an injury, a childhood disease, and an adult-onset disease.

Applicants further provide systems comprising such devices comprising a processor, as described and disclosed herein.

Applicants disclose a method of communicating a message to an identified user, said message comprising information of a first level of sensitivity, and comprising information of a second level of sensitivity, the method comprising: Providing said identified user with a first password and a second password; Providing a system for receiving or accessing said message, wherein said system comprises a plurality of levels, wherein a first level is available to said user when the user provides said first password, and a second level is available to the user when the user provides said second password; and a) Providing a version of the message containing only said information of said first level of sensitivity where said user provides said first password; and b) Providing a version of the message containing both said information of said first level of sensitivity and said information of said second level of sensitivity where said user provides said second password.

In embodiments, such a message may comprise information from a medical test, and wherein said information of said second level of sensitivity comprises medical information regarding a disease or condition selected from pregnancy, an infectious disease, a genetic disease or condition, a sexually-transmitted disease, a degenerative disease, a dementing disease or condition, a malignant disease or condition, an autoimmune disease or condition, a chronic disease or condition, an acute disease or condition, an injury, a childhood disease, and an adult-onset disease.

Accordingly, Applicants provide methods, systems, and devices in which a first password is used to provide access to a first level, and a second password is used to provide access to a second level, where access to the first level, and activities using that first level provide no indication of the existence of the second level. Some activities or information may be available to a user only pursuant to gaining access to the second level. In embodiments, activities using the second level may include activities available at the first level.

Access to a level allows viewing of information accessible via a device or system; or operation or control of a device or system; or writing, creating, or editing of information on or via a device or system; communication via a device or system; or other password-protected operation or activity. In embodiments, the operations, information, communications, and other password-protected activities differ between the first level and the second level.

Multiple levels of access to a device or system may be provided to a single user by providing two passwords to the user, wherein a first password is used to provide a first level of access to, or control of, the device or system, and a second password is used to provide a second level of access to, or control of, the device or system. In further embodiments, multiple levels of access to a device or system may be provided to a single user by providing more than two passwords to the user, wherein a first password is used to provide a first level of access to, or control of, the device or system, a second password is used to provide a second level of access to, or control of, the device or system, and one or more subsequent password(s) is (are) used to provide a subsequent level (or levels) of access to, or control of, the device or system. In embodiments, a single user may be provided with a single identifier, for which two passwords are associated. In further embodiments, a single user may be provided with a single identifier, for which more than two passwords are associated. Thus, in embodiments, a single user may be provided with a unique identifier, and two or more passwords may be associated with the identifier, wherein the different passwords provide different levels of access to the device or system.

In embodiments, a device or system may be configured for use by two or more identified users. Devices or systems may be configured for use by two or more identified users (each identified by a particular identifier for which two or more passwords are associated), the systems providing separate capabilities of use for each identified user. Thus, in embodiments, a plurality of identified users may be each provided with a unique identifier, and two or more passwords may be associated with each identifier, wherein the different passwords provide different levels of access to the device or system.

Accordingly, in embodiments, Applicants provide methods, systems, and devices requiring a plurality of passwords for access to information stored on the device, for access to communication links which may be used or accessed by the system or device, and for access to operations which may be commanded or performed by the system or device. In an embodiment where a system or a device comprises a computer, a cell-phone, a tablet computer, a dedicated link to a central database, a dedicated link to a sample analysis device, a dedicated link to an automated sample analysis device, a sample analysis device, an automated sample analysis device, or other device comprising a processor, Applicants provide methods, systems, and devices having a first password which allows limited operation of the computer or processor, providing access to a first level of operation, and provide methods, systems, and devices having a second password which allows unlimited operation of the computer or processor, providing access to a first level of operation and also a second level of operation of the computer or processor, wherein said second level of operation is invisible from the first level of operation, and both said first level and said second level of operation are visible or accessible from the second level of operation. A user having access to the first level is unaware of the existence of the second level; no indication of the existence of the second level, or of information, files, programs, utilities, hardware, or other capabilities unique to the second level is available or visible to a first level user.

In embodiments, Applicants provide a method, a system or a device requiring a plurality of passwords for access to information stored on the system or device, for access to communication links which may be used or accessed by the device, and for access to operations which may be commanded or performed by the device. In an embodiment where a system or a device comprises a computer, a cell-phone, a tablet computer, a dedicated link to a central database, a dedicated link to a sample analysis device, a dedicated link to an automated sample analysis device, a sample analysis device, an automated sample analysis device, or other device comprising a processor, Applicants provide methods, systems, and devices having a first password which allows limited operation of the computer or processor, providing access only to files, utilities, and programs of a first level of operation; Applicants provide methods, systems, and devices having a second password which allows greater operation of the computer or processor than does the first level, providing access to the first level of operation and also to files, utilities, and programs of the first level and also provides access to files, utilities, and programs of the second level; and Applicants provide methods, systems, and devices having a third password which allows unlimited operation of the computer or processor, providing access to all files, utilities, and programs available to the computer or processor, including those of the first and second levels as well as the additional files, utilities, and programs of the third level of operation of the computer or processor, wherein said second level is invisible to users operating at the first level of operation; wherein said third level is invisible to users operating at either the first or the second level of operation; and both said first level and said second level of operation are visible or accessible from the third level of operation. A user having access to the first level is unaware of the existence of the second level and of the third level; no indication of the existence of the second level or of the third level, or of information, files, programs, utilities, hardware, or other capabilities unique to the second level or unique to the third level is available or visible to a first level user. A user having access to the second level is unaware of the existence of the third level; no indication of the existence of the second level, or of information, files, programs, utilities, hardware, or other capabilities unique to the third level is available or visible to a second level user.

Further methods, systems, and devices may have four passwords; or may have five passwords; or more passwords, wherein each numbered level has access to that level and to lower-numbered levels, but provides no indication of the existence of, nor any access to, any higher-numbered level. In such embodiments having four, or five, or more passwords and levels, lower-numbered levels have no indication of, nor access to, information, files, programs, utilities, hardware, or other capabilities unique to higher-numbered levels.

Applicants further disclose computer-readable media having instructions for the implementation of the methods disclosed herein. Such computer-readable media may include computer programs which direct devices and systems having a processor to provide these methods and to operate according to these methods. Use of such computer-readable media, e.g., by the instructions thereon being read by, and implemented by, systems and devices having a processor allow the implementation of the methods disclosed herein. The computer-readable media disclosed herein may be read by, and implemented by, systems and devices at point of service locations, and may be used for the implementation of the methods disclosed herein at point of service locations.

In embodiments, non-transitory tangible computer-readable media comprising machine-executable code for implementing methods provided herein may be provided as a stand-alone and transportable product (e.g. a compact disk (CD), digital video disk (DVD), flash drive, magnetic tape, or other form of removable/insertable computer-readable media), such that the program or software stored thereon can be loaded onto one or more different computers, servers, or other computing devices, in order to implement one or more methods provided herein (or elements thereof). In other embodiments, non-transitory tangible computer-readable media comprising machine-executable code for implementing methods provided herein may be provided as part of a computing system involving multiple components (e.g. a server or personal computer). In embodiments, a user may interact with software on a server via a client application running on a user device, which is coupled to the server via a network. For example, the software may include a world wide web (WWW)-based interface to allow a remote user/client to access and view information such as health-related information, banking or financial information, purchase information, or other information which may include personal, confidential, or otherwise sensitive information. In embodiments, software running on a server may provide certain features to a user (e.g. a WWW-based interface), while performing various processes/operations on the server (e.g. providing messages related to, or providing access to, the results of clinical tests; allowing access to a bank account or accounts via an ATM; and other processes/operations).

In embodiments, methods provided herein may be implemented using hardware, software, or a combination thereof. In embodiments, software code may be implemented using one or more processors, which may be distributed between one or more computing devices. The methods disclosed herein may be performed at point of service locations.

In embodiments, provided herein are password-protected devices, and machine readable storage media (e.g., hard disk, CD, or other medium) (or multiple media) which contains a set of software instructions for execution by a processor for performing methods provided herein, with which a user providing a first password gains access to a first (e.g., basic) level, and with which that same user, providing a second password gains access to a second (e.g., hidden) level. The systems, devices, computer-readable media, and methods disclosed herein may be located, used, and performed at point of service locations.

The devices, systems, and methods disclosed herein may include, and may be performed with a device, or on a system, for processing a sample, such as a biological sample. Such a device, or system, for processing a sample may be a sample analysis device, including an automated sample analysis device, and may be part of an assay system, including an automated assay system. For example, systems as disclosed herein may include a communication assembly for transmitting or receiving results from a sample analyzed (“tested”), or results regarding an analyte (in a sample) detected by the device or system. In embodiments, a plurality of assays (tests) may be performed, and a plurality of results obtained, and a plurality of results communicated to an identified user, or accessed by an identified user. In embodiments, a sample analysis device, including an automated sample analysis, device may include, or may be operably connected to, a communication link or communication assembly comprising a channel for communicating information from the device to a computer, to a database, or to any other input or output device. Such a channel may be, e.g., a computer network, a telephone network, a metal communication link, an optical communication link, and a wireless communication link. In embodiments, devices and systems as disclosed herein may transmit signals to a central location, or to an end user, and may include a communication assembly for transmitting such signals.

These methods, devices and systems provide previously unavailable advantages. For example, these methods, devices and systems provide greater flexibility for users, allowing confidentiality for information, operations, and communications at one level by use of a first password, while providing a different level of access, capability, operation, communication, and information by use of a second password. Such different levels of password-protected access, for example, allow sharing of access to selected information, operations, and communications while maintaining confidentiality and control for other information, operations, and communications. Such different levels of password-protected access are provided without alerting users at a lower level that there may exist information, operations, or communications at a higher level to which they are denied access; in this way, higher level information, operations, and communications gain an additional, novel level of protection, in that not only is access denied to those lacking the proper password, but those lacking the proper password are denied any knowledge of the existence of such information, operations, or communications. Such additional confidentiality is useful, for example, where the hidden information, operations, or communications are private, or sensitive, or confidential for personal, business, trade-secret, or other reasons.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1A shows a schematic diagram illustrating a system capable of providing two or more levels of access and operation, including a first level accessible by a first password, and a second level accessible by a second password (where the second level is invisible during operations at the first level). Access, operations, and information (e.g., files) at the second level may include all access, operations, and information available at the first level, and further includes other access, operations, and information available only at the second level (i.e., to users having possession of the second password). Further levels of access and operation are similarly invisible to lower levels, while providing additional access, operations, or information not available at lower levels.

FIG. 1B shows a schematic diagram illustrating a system capable of providing two or more levels of access and operation, including a first level accessible by a first password, and a second level accessible by a second password (where the second level is invisible during operations at the first level). In this embodiment, the elements enclosed in the large, thin-lined box may be housed together, or operably linked together, to form a device or local system. As indicated in the figure, the device or local system may interact with a network, e.g., may communicate with, or utilize capabilities of, other devices, systems, or users via a network. Different levels of operation are available according to the password used to gain access to, or control of, the device or local system shown in the figure.

FIG. 2 shows a flow diagram illustrating a system having two levels, a first level accessible by a first password, and a second level, invisible during operations at the first level, accessible by a second password. Upon determination which of two passwords was entered (indicated by the diamond labeled “Compare”) access is provided to the level allowed by the password entered by a user. Access, operations, and information (e.g., files) at the second level include all access, operations, and information available at the first level, and further include other access, operations, and information available only at the second level (i.e., to users having possession of the second password). Brackets indicate steps enclosed that are not required where user identification is not required.

FIG. 3A provides a schematic diagram of a display showing entry of a first level password suitable for gaining access to a first level (the arrow pointing right indicating that such access and operation is available to the user after entry of the password shown at the left). Examples of operations and information available at the first level are shown at the right in FIG. 3A.

FIG. 3B provides a schematic diagram of a display showing entry of a second level password suitable for gaining access to a second level (the arrow pointing right indicating that such access and operation is available to the user after entry of the password shown at the left). Examples of operations and information available at the second level are shown at the right in FIG. 3B. In addition to the limited number of operations and files which were available at the first level (as shown in FIG. 3A), additional operations and files are accessible at the second level. These additional operations and files are not visible to, nor available to, users at the first level.

FIG. 4A provides a schematic diagram of a display showing entry of a first level password associated with an identified user, leading to access to a first level (the arrow pointing right indicating that such access and operation is available to the user after entry of the password shown at the left). The limited number of operations, and files available at the first level are shown in the right of FIG. 4A.

FIG. 4B provides a schematic diagram of a display showing entry of a second level password associated with the same identified user as indicated in FIG. 4A, leading to access to a second level (the arrow pointing right indicating that such access and operation is available to the user after entry of the password shown at the left). In contrast to operations at the first level, in addition to all of the limited number of files and documents accessible at the first level, further operations and files are accessible to the user at the second level.

### DETAILED DESCRIPTION

Description and disclosure of examples of methods, devices, and systems which may use, or be used with, methods, devices, and systems disclosed herein, including sample analysis devices, automated sample analysis devices, systems comprising sample analysis devices (including automated sample analysis devices), and their uses may be found, for example, in: U.S. Pat. No. 8,088,593; U.S. Pat. No. 8,380,541; U.S. Pat. No. 8,392,585; U.S. patent application Ser. No. 13/769,779, filed Feb. 18, 2013; U.S. patent application Ser. No. 13/769,798, filed Feb. 18, 2013; U.S. patent application Ser. No. 13/769,820, filed Feb. 18, 2013; U.S. Application Ser. No. 61/766,095, filed Feb. 18, 2013; U.S. patent application Ser. No. 13/784,814, filed Mar. 4, 2013; U.S. Application Ser. No. 61/800,606, filed Mar. 15, 2013; U.S. Patent Application Ser. No. 61/814,799, filed Apr. 22, 2013; U.S. Patent Application 61/805,923, filed Mar. 27, 2013; U.S. Patent Application Ser. No. 61/858,604, filed Jul. 25, 2013; U.S. Patent Application Ser. No. 61/864,505, filed Aug. 9, 2013; U.S. Application Ser. No. 61/673,245, filed Jul. 18, 2012; PCT/US2012/57155, filed Sep. 25, 2012; U.S. patent application Ser. No. 13/244,949, filed Sep. 26, 2011; and U.S. patent application Ser. No. 14/183,503, filed Feb. 18, 2014, the disclosures of which patents and patent applications are all hereby incorporated by reference in their entireties.

In this specification and in the claims which follow, reference will be made to a number of terms which shall be defined to have meanings as discussed in the following.

As used herein, “identification” and “user identification” may refer to the act of identifying a user, to a username which identifies an individual using a device or system, or to any material or implement used to identify a user. A user may enter a username, or an identification number, or other identification symbol in order to be identified to a device or system. Material or implements used to identify users may include, without limitation, a user name; a user identification number; a date of birth, maternal name, or other personal identification fact or name; identification cards or tags (including, e.g, an automatic teller machine card (ATM card); a credit card; an identity card; a bar code; a quick response code (QR code); a radio-frequency identification device (RFID); a memory stick; a magnetic strip; or other identification. Identification may be by biometric means, including by thumb, finger, hand, foot, or other print; by scan or inspection of an ear, eye, face, or other personal characteristic; by electronic means (e.g., body scan, brain scan, or other electronic or physiologic means); or by other means to identify a user.

An “identified user” is an individual associated with, and identified by, user identification as discussed above. An identified user will typically be the individual associated with a particular user identification; however, should an individual share their user identification particulars (e.g., user identification name or number) with others, those others may be treated as an identified user as well when making use of the user identification (e.g., where one family member is entered into a system as an identified user, and shares the log-in information (e.g., user name and password) with other family members, any one of those family members may log-in as the identified user, for systems and methods in which the identifiers are not physical identifiers linked only to that identified user).

As used herein, with respect to password-protected systems and devices, the terms “system” and “device” refer to any password-protected device or system, of any level of complexity or sophistication. Such devices and systems may include a processor. Thus, such a system or such a device may be, e.g., a cellphone; a tablet computer; a desk-top computer; a dedicated link to a central database; a dedicated link to a sample analysis device; a dedicated link to an automated sample analysis device; a sample analysis device; an automated sample analysis device; an ATM machine; a web-interface, a brokerage account accessible by phone or internet, an email system; a medical record database; or other device or system. It will be understood that where a device may be, or requires, access to or communication with other components of a system, reference to the device inherently implies and includes such access to or communication with other components of the system. For example, reference to an “ATM machine” includes reference to an ATM network including an ATM machine and associated communication and computing devices and systems, including databases (e.g., storing bank account information), encryption of communications, password-identification functionality, and all other aspects of a working ATM network. For example, reference to a “cellphone” includes reference to the handheld device itself, and also includes any associated communication and computing devices and systems, including password-identification functionality, encryption of communications, central switching and computing functionality, and all other aspects of a working cellphone network. Similarly, reference to a tablet computer; a desk-top computer; a dedicated link to a central database; a dedicated link to a sample analysis device; a dedicated link to an automated sample analysis device; a sample analysis device; an automated sample analysis device; or any other computer or device including a processor, includes and refers to associated software and hardware used to make a functional device, including display, operating systems, communication links and other input and output devices and functionality. Reference to a brokerage account accessible by phone or internet (whether accessible by phone, internet, or other access channel) refers to an account (typically consisting of money, stocks, bonds, trusts, or other financial instruments) includes reference not only to the account itself, but also to web-sites, communication links, databases, and other associated systems used to provide access and functionality to account-holders accessing their accounts by internet, cellphone, or other link.

As used herein, the term “visible” refers to files, operations, and information (e.g., records, databases, tests ordered, test results, and other information related to an identified user, or of interest to an identified user) that may be displayed to, viewed by, or otherwise seen by or imparted to an identified user with the right to such information.

As used herein, the term “accessible” refers to files, operations, and information (e.g., records, databases, tests ordered, test results, and other information related to an identified user, or of interest to an identified user) that may be displayed to, viewed by, downloaded, copied, commanded, executed, or otherwise made available to or operated by an identified user with the right to such information or the right to perform such actions. In some cases, where the identified user has such rights, accessible information may be added to, or edited (in some cases), or otherwise altered.

Reference to a medical record database visible or accessible by phone, internet, or other communication channel includes reference not only to the medical record database itself, but also to web-sites, communication links, databases, and other associated systems used to provide access and functionality to patients and health-care providers accessing medical records by internet, cellphone, or other link. As used herein, a “medical record database” may include not only medical records, but may also include messages between a health-care provider and a patient; information regarding test results, and the interpretation of such results; information regarding symptoms, and information regarding symptoms; information regarding health and treatment options and strategies; and other health-related information. In some cases, a payer (such as an insurance company) or other third-party (e.g., a parent of a patient) may have access to medical records and a medical record database. In some cases, a payer or other third-party may have a password, which may include a first-level, or second-level, or other level password, providing access to an appropriate level of the system or device.

As used herein the terms “phone”, “cell-phone”, and the like may be used interchangeably to refer to devices and systems providing communications links which typically include voice communications and may include data, video, and other communication links and capabilities as well. Such communication links may include encrypted or other secure communication links. Use of a phone may require a password; according to the methods disclosed herein, phone devices and systems may utilize two, or more, passwords to provide multiple levels of access, multiple levels of service, or the like, in which a second level (accessible by second password) remains invisible to, and inaccessible to, users of a first level.

Reference to “an email system” includes reference to all communication links, databases, and other associated systems used to provide access and functionality to email users sending and receiving messages, and accessing their email accounts and records by internet, cellphone, or other link.

The term “network” as used herein, refers to a local area network (LAN), metropolitan area network (MAN), a wide area network (WAN), or other network. In some situations, a network includes the Internet. A network may include fiber optic, wired and/or wireless components. Thus, a network may be any structure which can support the operable connection of and data transfer between two or more computing devices, such as a local area network (LAN) or a wide area network (WAN), and may include, for example, an intranet, an enterprise private network, the Internet, cellular, or satellite networks. Computing devices (e.g. servers, external data sources, and user devices) may connect to the network by wired or wireless technologies. For example, a computing device may connect to the network via wired technologies such as a dial-up connection with a modem, a direct link such as TI, ISDN, cable, Firewire, USB, or Ethernet wire. In other examples, a computing device may connect to the network 130 via wireless technologies such as Bluetooth, RTM, infrared (IR), radio frequency (RF), ZigBee, Z-wave, wireless USB, code division multiple access (CDMA) or global system for mobile communications (GSM). In embodiments, data may be encrypted before it is transmitted over the network.

The term “electronic device,” as used herein, refers to a computer device configured to connect to a network. In some cases, an electronic device is a portable electronic device. Examples of electronic devices include Smart phones (e.g., iPhone®, Android®-enabled phone, HTC® phone, Blackberry®), laptops, tablet personal computers (e.g., iPad®), and desktop computers (e.g., workstations, servers), cameras, gaming stations (e.g., Sony® PlayStation®, Microsoft® Xbox), televisions, music players (e.g., MP3 players, radios, CD players) and video players (e.g., DVD players). Electronic devices may be included in other components. For instance, an electronic device may be part of a residential or commercial building, vehicle, or aircraft.

The term “network-enabled device,” as used herein, refers to an electronic device configured to connect to, reconnect to, and communicate with one or more electronic devices with the aid of a network. In some example, a network-enabled device (also “network device” herein) includes a cellphone such as, e.g., a Smart phone, and personal computer (PC). As an example, a network-enabled device is a desktop personal computer (PC), laptop PC, mainframe computer, set-top box, personal digital assistant, cellular telephone, media player, web pad, tablet PC, slate PC, or cellphone. In some situations, a network-enabled device includes a network interface for facilitating network connectivity. A network interface includes, for example, an Ethernet interface for connectivity to a network through a wired connection, or a wireless interface for connectivity to a wireless provider that in turn provides connectivity to a network. A network-enabled device may include multiple wireless interfaces. A wireless provider may include one or more of a Wi-Fi (or WiFi) router and one or more channel access methods. In some cases, a channel access method is selected from frequency division multiple access (FDMA), wavelength division multiple access (WDMA), orthogonal frequency division multiple access (OFDMA), based on Orthogonal, frequency-division multiplexing (OFDM), single-carrier FDMA (SC-FDMA) (or linearly-precoded OFDMA (LP-OFDMA)), time-division multiple access (TDMA), code division multiple access (CDMA) (or spread spectrum multiple access (SSMA)), direct-sequence CDMA (DS-CDMA), frequency-hopping CDMA (FH-CDMA), orthogonal frequency-hopping multiple access (OFHMA), multi-carrier code division multiple access (MC-CDMA), space division multiple access (SDMA), packet mode channel access methods (e.g., contention based random multiple access methods), duplexing methods (e.g., time division duplex (TDD), frequency division duplex (FDD)), global system for mobile communications (GSM), GSM with GPRS packet, bluetooth packet mode communication, IEEE 802.11b wireless local area networks (WLAN's), high performance radio local area network (HIPERLAN/2) wireless networks, and G.hn. A wireless provider may be configured for second-generation wireless telephone technology (2G), third generation mobile telecommunications (3G), fourth generation cellular wireless standards (4G) or LTE Advanced (LTE) communication standard.

A network-enabled device may include multiple interfaces. In some cases, a network-enabled device includes an Ethernet interface and wireless interfaces for connectivity to a WiFi router, CDMA provider and/or GSM provider.

As used herein, the term “a dedicated link to a central database” refers to a communication channel linking a device with a central database, where the central database may be any database, whether stored on a single machine or memory device, or in a single location, or distributed between multiple devices or locations. Such a communication channel may be any communication link, whether using a landline, a wireless connection, or other connection, or a combination thereof, including any connection as discussed above regarding network-enabled devices.

As used herein, the terms “dedicated link to a sample analysis device” and “dedicated link to an automated sample analysis device” refer to a communication channel linked to a sample analysis device or an automated sample analysis device. Such a communication channel may be any communication link, whether using a landline, a wireless connection, or other connection, or a combination thereof, including any connection as discussed above regarding network-enabled devices.

As used herein, the terms “computer-readable medium” and its plural “computer-readable media” refer to any medium which may store machine-readable information capable of being read by a computer or other device having a processor. Computer readable-media include, for example, floppy disks, compact disks (CDs), digital video disks (DVDs), flash drives, hard drives, bubble memory, magnetic tape, paper tape, punch cards, read-only memory (ROM) chips, and other forms of storing and transporting information (e.g., computer software, data, and other information and instructions).

As used herein, the term “information”, such as information accessible at a level of access, refers to any information, including data, datafiles, spreadsheets, documents, lists, graphs, results of calculations or other processing or manipulation of data, records (of any kind, including medical records, financial records, historical records, communication logs, records of correspondence, the correspondence itself, and other records), software, and other information.

As used herein, the term “communication”, such as a communication or communication link accessible at a level of access, refers to any means of communication, and any messages (e.g., email messages), instant messaging, signals, streaming, packet-based, analog, digital, via a wired connection, via wireless interface, including any communication methods and systems disclosed herein, and other communications.

As used herein, the term “operation” such as an operation accessible at a level of access, refers to any operation performed, or capable of being performed, by the device or system. The ability of a device or system to perform an operation may depend on its hardware configuration, software available for use, and combinations of these (e.g., software may command or control the use of hardware of a device or system). Thus, where access to a software application is limited to, for example, level 2 access, the operations performed using that software application are available to users accessing level 2, but remain unknown to, and unavailable to, users accessing level 1.

As used herein, the term “option” indicates that a choice may be made between two or more possibilities, such as two or more choices of password to enter for a single username. The terms “optional” or “optionally” means that the subsequently described circumstance may or may not occur, so that the description includes instances where the circumstance occurs and instances where it does not. For example, if a device optionally contains a feature, this means that the feature may or may not be present, and, thus, the description includes both structures wherein a device possesses the feature and structures wherein that feature is not present.

As used herein, a “sample” is a small portion of a larger entity; for example, a clinical sample, also referred to as a biological sample, is a small portion of, or an excretion or secretion or, the subject (e.g., person) from which it is obtained. Thus, a biological sample may be a blood sample; a urine sample; a stool sample; a sample of sweat or tears; a sample obtained by swabbing a subject (e.g., a throat, cheek, or nasal swab sample); or other sample. In embodiments, a biological sample is a fluid sample (e.g., blood, urine, saliva, sweat, tears, and other biological fluids). A biological sample may be, e.g., blood, serum, plasma, obtained from a nasal swab or a nasopharyngeal wash, saliva, urine, tears, gastric fluid, spinal fluid, stool, mucus, sweat, earwax, oil, glandular secretion, cerebral spinal fluid, tissue, semen, and vaginal fluid, throat swab, breath, hair, finger nails, skin, biopsy material, placental fluid, amniotic fluid, cord blood, lymphatic fluids, body cavity fluids, sputum, mucus, pus, microbiota, meconium, breast milk and/or other excretions

As used herein, the term “sample analysis device” refers to a device configured to analyze one, or more, biological samples, where analysis includes identifying a target analyte, and includes detecting the presence of, and determining the amount of, a target analyte (where the analyte may be, e.g., a nucleic acid molecule, a peptide or protein molecule, a lipid, a hormone, a cell, and a cell characteristic or property) in a sample. A sample analysis device may be configured to receive a sample; transport a sample; to process a sample; to divide a sample; to dilute a sample; to inspect a sample; to image a sample; to mix a sample with reagents; to perform chemical and physical reactions with the sample; to detect the results of such chemical and physical reactions; to quantify the results of such inspection, imaging, and chemical and physical reactions; to analyze the results of such inspection, imaging, and chemical and physical reactions; to store the results of such inspection, imaging, and chemical and physical reactions; to report the results of such inspection, imaging, and chemical and physical reactions; and may have other capabilities. Thus, for example, a sample analysis device may include a sample collection unit, a sample handling system (e.g., a fluid handling system for use with fluid samples), a detector, a user interface, an input device (e.g., a switch, a screen, a keyboard, an electronic link, etc.) and an output device (e.g., a screen, a display, a printer, an audio output, an electronic link, etc.)

A sample analysis device (which may be part of a system) is suitable for evaluating a biological sample, and may be configured to process the biological sample. For example, a sample analysis device (which may be part of a system) may include one or more of (i) a sample collection unit configured to receive the biological sample; (ii) a sample preparation unit configured to prepare the biological sample for the subsequent qualitative and/or quantitative evaluation; and (iii) transmission unit configured to transmit the data to an identified user, clinician, database, or other data recipient; (b) a processor that processes said data for the subsequent qualitative and/or quantitative evaluation of said biological sample. A processor may communicate with a database comprising one or more medical records related to the subject providing the sample, and may communicates with other databases (e.g., with a payer database comprising insurance information related to the subject). A sample analysis device (which may be part of a system) may also be capable of generating data necessary for a subsequent qualitative and/or quantitative evaluation of said biological sample.

Sample analysis devices, including automated sample analysis devices, may be configured to detect or measure a target analyte, or multiple target analytes in biological samples. In embodiments, automated sample analysis devices may provide rapid assays which require only small amounts of sample, such as only small amounts of blood. Methods, devices, and systems providing rapid tests, and which require only small biological samples, provide advantages over other methods, compositions, assays, devices, and systems.

As used herein, the term “automated sample analysis device” refers to a sample analysis device which may be operated automatically; for example, an automated sample analysis device may operate according to a protocol (or a plurality of protocols), where, once begun, the protocol determines the operation of the device, and so governs the analysis of the sample. One or more protocols may be built into the automated sample analysis device; or one or more protocols may be communicated to the device, e.g., via a communication link with an external source or repository of protocols, or provided to the device along with the sample to be analyzed (e.g., coded on a container, or label attached to a container, containing a sample to be analyzed according to that protocol or those protocols).

For example, a sample analysis device, including an automated sample analysis device, may detect or measure analytes in a sample of blood, urine, or other fluid biological sample, where the fluid sample may have a volume of no more than about 1000 μL, or no more than about 500 μL, no more than about 250 μL, or no more than about 150 μL, or no more than about 100 μL, or no more than about 50 μL, or no more than about 25 μL, or no more than about 10 μL, or less than about 10 μL. Sample analysis devices, including automated sample analysis devices, may be configured to analyze a sample in less than about one hour, or, in embodiments, in less than about 40 minutes, or in less than about 30 minutes.

The terms “automated assay device”, “automatic assay device”, “automatic sample analysis device”, and similar terms referring to systems comprising such devices (e.g., automated sample analysis system”, “automated assay system”, “automatic assay system”, “automatic sample analysis system”, and the like) may be used interchangeably with the term “automated sample analysis device”.

As used herein, the term “infectious disease” refers to any disease which may be transmitted from one person to another, or from one animal to another, or from an animal to a person. Infectious diseases are typically caused by infectious agents such as viruses, bacteria, fungi, yeast, mycoplasma, and other micro-organisms.

As used herein, the term “chronic disease or condition” refers to diseases or conditions which persist for long times. Such conditions may include chronic pulmonary obstruction, heart failure (including cardiac insufficiency), fungal infections, acquired immune deficiency syndrome (AIDS), and other diseases and conditions which do not resolve in a short time.

As used herein, the term “acute disease or condition” refers to diseases or conditions which typically resolve in a short time, e.g., over a period of days or weeks (or occasionally, months), such as many viral or bacterial infections, transient ischemic attacks (TIAs), mild cardiac infarction, injuries (e.g., sprains, bone breaks, cuts, and other injuries), and other diseases and conditions.

As used herein, the term “degenerative disease” refers to any disease which may progress and, over time, lead to the degeneration of an organ, muscle, tissue, or physiological capability of a subject suffering from the disease. A degenerative disease may be a genetic (e.g., hereditary) disease, or may be an infectious disease, or may be an autoimmune, or other disease. A degenerative disease may have an unknown cause. Degenerative diseases include, but are not limited to, multiple sclerosis, Parkinson's disease, Huntington's disease, amyotrophic lateral sclerosis, Alzheimer's disease, muscular dystrophy, cystic fibrosis, and other diseases.

As used herein, the term “dementing disease or condition” refers to any disease which is characterized by sudden or progressive loss of mental function. Such diseases may be particular instances of degenerative diseases (e.g., Alzheimer's disease Parkinson's disease, and other diseases), may be due to chronic infectious diseases (e.g., syphilis, AIDS dementia, and other diseases), or may be due to acute conditions or injury (e.g., stroke, head injury, drowning, encephalitis, or other disease or condition). A dementing disease may have an unknown cause.

As used herein, the term “childhood disease” refers to diseases common in children, such as measles, mumps, whooping cough, ear infections, sore throats, and other diseases.

As used herein, the term “adult-onset disease” refers to diseases of adulthood, often diseases which take years to become evident, and which are typically uncommon in children, such as adult-onset diabetes, heart disease, stroke, most cancers, osteoporosis, and other diseases.

As used herein, the term “malignant disease or condition” includes, but is not limited to, cancer, including metastatic cancer, cancer of the blood, solid tumors, benign tumors, and other cancerous or proliferative diseases and conditions.

As used herein, the term “genetic disease or condition” refers to a disease caused by, or whose incidence is highly correlated with, a person's genetic makeup, whether inherited or due to mutation; genetic diseases and genetic conditions include, but are not limited to, many cancers (e.g., breast and ovarian cancer linked, e.g., to the presence of mutations in the BRCA1 or BRCA2 gene); some forms of Alzheimer's disease (e.g., those linked to mutations in the amyloid precursor gene protein, or in a presenilin gene, or other genes); cystic fibrosis; Down Syndrome; Duchenne and Becker Muscular Dystrophy; Niemann-Pick disease; Tay-Sachs disease; Bloom's Syndrome; Huntington's disease; celiac disease (which is also an autoimmune disease); Noonan Syndrome; Amyotrophic Lateral Sclerosis; Marfan Syndrome; Sickle-Cell Anemia; Thalassemia; Retinitis Pigmentosa; and other genetic and inherited diseases and conditions.

As used herein, the term “sexually transmitted disease” refers to a disease commonly acquired via sexual contact; such diseases include, but are not limited to, for example, acquired immune deficiency syndrome (AIDS; also known by the name of the causative virus, human immunodeficiency virus (HIV)); syphilis; gonorrhea; human papillomavirus (HPV) infections; chlamydia infections; cytomegalovirus infections; pelvic inflammatory disease; pubic lice; scabies; infections caused by some herpes viruses, and other diseases.

As used herein, the term “autoimmune disease” refers to a disease whose symptoms are due to loss of function or inflammation caused by a subject's own immune system; autoimmune diseases include, but are not limited to, rheumatoid arthritis, multiple sclerosis, myasthenia gravis, type I diabetes, pernicious anemia, Sjogren's syndrome, lupus erythematosis, Grave's disease, celiac disease (which is also a genetic disease), Addison's disease, and other diseases.

As used herein, the term “point of service location” and its acronym “POS” refer to stores, clinics, pharmacies, and other locations where a subject may receive a service, which may be a clinical service. POS locations may include locations where a subject may receive a service (e.g. testing, monitoring, treatment, diagnosis, guidance, sample collection, ID verification, medical services, non-medical services, etc.), and may include, without limitation, a subject's home, a subject's business, the location of a healthcare provider (e.g., doctor), hospitals, emergency rooms, operating rooms, clinics, health care professionals' offices, laboratories, retailers [e.g. pharmacies (e.g., retail pharmacy, clinical pharmacy, hospital pharmacy), drugstores, supermarkets, grocers, etc.], transportation vehicles (e.g. car, boat, truck, bus, airplane, motorcycle, ambulance, mobile unit, fire engine/truck, emergency vehicle, law enforcement vehicle, police car, or other vehicle configured to transport a subject from one point to another, etc.), traveling medical care units, mobile units, schools, day-care centers, security screening locations, combat locations, health assisted living residences, government offices, office buildings, tents, bodily fluid sample acquisition sites (e.g. blood collection centers), sites at or near an entrance to a location that a subject may wish to access, sites on or near a device that a subject may wish to access (e.g., the location of a computer if the subject wishes to access the computer), a location where a sample processing device receives a sample, or any other point of service location described elsewhere herein.

Devices, Systems and Methods

At the simplest level of design and operation, a device or system may not require any password protection. For example, the keys of a cellphone may be designed to accept input (e.g., finger pressure) and to pass that input to other systems in order to make a phone call, or to call up contact information from memory, or other action. A website, accessed via a web-browser, for example, may display content, and may allow access to various links or pages, to all users who access the site. Such a device or system may be considered a primitive level device or system.

In embodiments, the methods, devices, and systems disclosed herein may include a non-password protected level (e.g., as a default level). However, such a non-password protected level provides no access to any of the password-protected levels, files, or functions. As discussed herein, Applicants disclose novel methods, devices and systems providing multiple levels of access and multiple levels of functionality, in addition to, and irrespective of whether or not, such methods, devices and systems also include or provide a primitive, non-password-protected, level.

A cellphone, or tablet computer, or desk-top computer, or website, or other device or system may require a password to gain access to part or all of the functionality of the device or system. Upon provision of the password, some functions, or links (e.g., pages) are available that were prohibited to users who have not provided a valid password. Such a device or system may be considered “password-protected.” Such password protection is independent of any encryption or secure communication links which may also be used by the device or system; the password determines the level of access, while encryption protects the communications at that level (or all levels) of use of the device or system.

A dedicated link to a central database, or a dedicated link to a sample analysis device (including an automated sample analysis device), or a sample analysis device itself (including an automated sample analysis device), or other device or system may require a password to gain access to part or all of the functionality of the device or system. Upon provision of the password, some functions, or links (e.g., test results, lab-reports, patient clinical history, etc.) are available that were prohibited to users who have not provided a valid password. Such a device or system may be considered “password-protected.” Such password protection is independent of any encryption or secure communication links which may also be used by the device or system; the password determines the level of access, while encryption protects the communications at that level (or all levels) of use of the device or system.

Devices, systems and methods disclosed herein include at least two levels of operation, where a level typically requires a password in order to gain access to files and functionality of the device or system. Thus the novel devices and systems, and the novel methods performed with such devices and systems, may include at least two levels of password protection.

A level of operation differs from merely a “user” level and an “administrator” level in that the “user” is aware of the existence of the administrator level to which the user typically lacks access, and the user is dependent upon the existence and greater access of the administrator level. In contrast, methods and systems according to the embodiments disclosed herein differ from administrator and user “log-in” identities in at least two ways: 1) unlike files and programs on a computer subject to an administrator, the second level of operation is invisible to a user who only has access to the first level of operation; 2) being unaware of the second level, the first level user does not depend upon anything accessible only to the second of operation.

A level of operation differs from merely different “log-in” identities in at least two ways: 1) the second (or further) level of operation is invisible to a user who only has access to the first level (or other lower level) of operation; 2) the second level of operation provides access to “hidden” files, “hidden” programs, and “hidden” communications not visible and not accessible to first level users. Thus, for example, while a computer with multiple log-ins for different users may only allow access to some programs to some users (e.g., to administrative users) the existence of programs and files that are locked to lower-level users is not hidden, nor the existence of other log-in profiles is not hidden to lower-level users. Optionally, a level of operation can be viewed as transforming the automated sample analysis device, computing device, apparatus, or other host hardware to be operating in a different state or condition. In one embodiment, this can be viewed as allowing the device to be in full, greater, or other enhanced operating state with access to one or more functionality, one or more databases, or other capability that is otherwise unknown to exist to a user at a less secure level of operation.

In contrast, according to the novel methods, devices, and systems disclosed herein, a user possessing a first-level password will not be aware that a second level even exists, and a user possessing a first-level password will not be aware of their lack of access to files or operations available to s second-level user. Hiding the identity of the existence of higher levels, and of files and operations available at such (unknown) levels, provides further security, secrecy, and protection to files, information, and operations available to second-level users.

It will be understood that the novel methods, devices, and systems disclosed herein may include three levels, or four levels, or more; each higher level remains invisible to users with password-protected access to a lower level; and the existence of further higher levels remains hidden and unknown to users with password-protected access to a lower level.

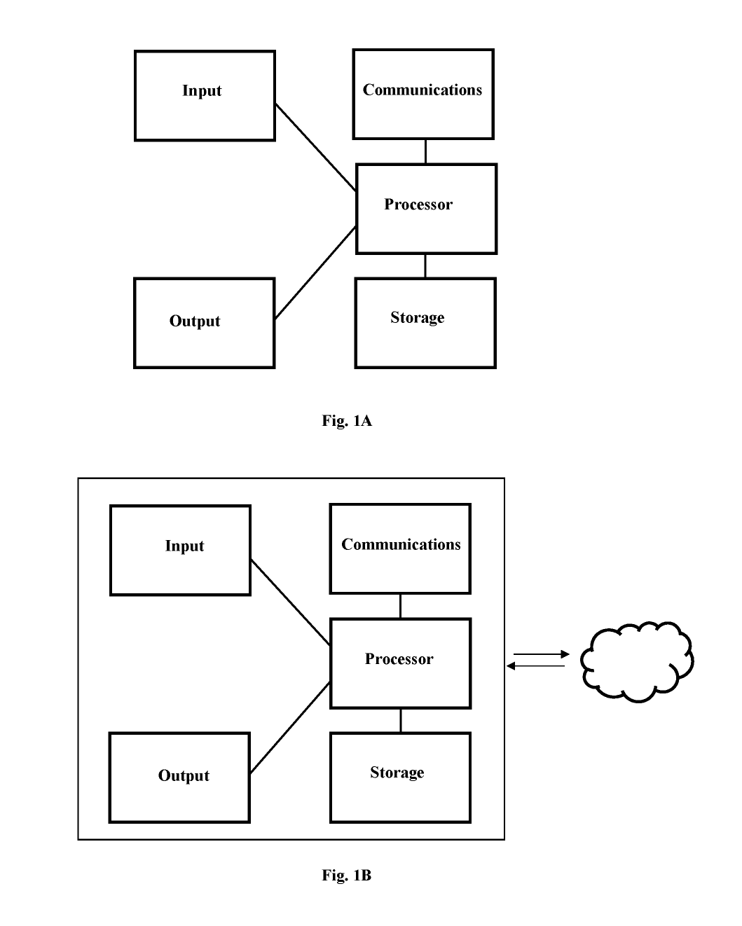

FIG. 1A shows a schematic diagram illustrating a system capable of providing two or more levels of access and operation, including a first level accessible by a first password, and a second level accessible by a second password (where the second level is invisible during operations at the first level). Access, operations, capabilities, and information (e.g., files) at the second level may include all access, operations, capabilities, and information available at the first level, and further includes other access, operations, capabilities, and information available only at the second level (i.e., to users having possession of the second password). In embodiments, there may be no overlap in the operations, capabilities, and information available at the two levels (i.e., the operations, capabilities, and information of level one is different than the operations, capabilities, and information available at level two). In embodiments, there may be some overlap in the operations, capabilities, and information available at the two levels (i.e., some operations, capabilities, and information are available at both level one and at level two, although users at level 1 remain unaware of the existence of level 2 and its operations, capabilities, and information). In embodiments, access, operations, capabilities, and information (e.g., files) at the second level includes all access, operations, capabilities, and information available at the first level, and further includes additional access, operations, capabilities, and information available only at the second level (i.e., to users having possession of the second password). Further levels of access and operation are similarly invisible to lower levels, while providing additional access, operations, capabilities, or information not available at lower levels.

Referring to FIGS. 1A and 1B, the boxes labeled “input” refer to any device or method for entering information or commands to the devices or systems disclosed herein. For example, input may be by a keyboard, or touch-pad, or touch-screen, camera, microphone, or display on a cellphone, or by voice command, or by manipulation of computer mouse, track-ball, switches, keys, knobs, or any other means of delivering information or commands. A display may include, for example, a cathode ray tube, a plasma display, a liquid crystal display (LCD), or light-emitting diode (LED)—based display, or other display. The boxes labeled “output” in FIGS. 1A and 1B refer to any device or method for providing information from the devices or systems disclosed herein to a user. For example, output may be by a display, or printer, or projector, or speaker, or other indicator or output device. The boxes labeled “communications” in FIGS. 1A and 1B refer to any device or method for transferring information or commands from one device to another, or one system to another, or between devices and systems. For example, communications may include internet communications, or telephone communications (whether via wireless, or landline, fiber optic, or other means or combination of means), dedicated or hard-wired communications, or combinations thereof, by any means. The boxes labeled “processor” in FIGS. 1A and 1B refer to any device or method for performing mathematical, addressing, sorting, ordering, routing, or other operation typically performed by a computer processing unit (CPU) or the like. A processor typically is a device that may be programmed to perform any of multiple operations as directed by protocols and instructions provided by, e.g., a computer program. The boxes labeled “storage” in FIGS. 1A and 1B refer to any device or method for retaining information (including data, programs, addresses, settings, and other information); such information is typically stored for use by a processor. Information may be stored transiently (e.g., in volatile memory, such as random access memory (RAM); may be stored semi-permanently (e.g., on flash memory); may be stored permanently (e.g., on a hard-drive, CD, or in read-only memory (ROM); or in other ways, or in any combination thereof.

FIG. 1B shows a schematic diagram illustrating a system capable of providing two or more levels of access and operation, including a first level accessible by a first password, and a second level accessible by a second password (where the second level is invisible during operations at the first level). In this embodiment, the elements enclosed in the large, thin-lined box may be housed together, or operably linked together, to form a device or local system (e.g., may act as a single operable unit). As indicated in the figure, access to a network (indicated by the cloud symbol) is provided in this embodiment; the device or local system may interact with a network, e.g., may communicate with, or utilize capabilities of, other devices, systems, or users via a network. Communication with a network may be two-way communication, that is information and commands may go from the device or local system (elements within the box) to the network, and information and commands may go from the network to the device or local system. Different levels of operation are available according to the password used to gain access to, or control of, the single device or operable unit shown in the figure.

A device or system having features disclosed herein may have two levels, a first level accessible by a first password, and a second level accessible by a second password. Access to the operations and files of the first level, upon entering the first password, apparently provides full use of the system since the existence of, and access to, files, operations, and any other aspect of the second level is invisible to users having logged-in with the first level password; however, users logging in with a second password gain access to the second level, which is invisible to those logging in with the first password. In embodiments of two level devices, systems and methods, access to the operations and files of the second level, upon entering the second password, provides full use of the system. In embodiments having three, or more, levels of access, access to the operations and files of the second level, upon entering the second password, apparently provides full use of the system since the existence of, and access to, files, operations, but the existence of, and aspects of, the third (or higher) level is invisible to users having logged-in with the second level password.

An operation or file is visible to a user if the user is presented with, or allowed to find, an icon, file name, listing, or other indication of the presence of the operation or file. An operation or file is invisible to, or hidden from, a user if the no icon, file name, listing, or other indication of the presence of the operation or file is allowed to be presented to the user. In embodiments, an invisible file or operation is not available to users of a particular level, even if such a file or operation would otherwise be automatically called or accessed by a command, operation, or other action allowed to the user at a particular level.

An operation is accessible to a user if the user is allowed to command that operation, or to otherwise make use of the operation or its functionality. Such command or use of an operation or functionality may be explicit (e.g., a user clicks on an icon, or types a command, or opens a communication link, to initiate or control the operation) or may be implicit (e.g., a program or communication link may automatically call or initiate a subroutine, dynamic link library (DLL), communication protocol, or other operation pursuant to an explicit command by a user).

Note that the use of the terms “first” and “second”, with regard to levels and passwords, does not connote any requirement for sequential ordering or use of these passwords; a user of a two-level system or device, having possession of both the first password and the second password, may enter the second password (and obtain access to and information about both the second and first level files and operations of the system or device); or may enter the first password (and obtain access to and information about only the first level files and operations of the system or device). A user logging in with the first password will not be able to detect or access second-level files or operations. Thus, for example, no icons or links to any second-level files or operations will be displayed to a first-level user; a listing of files on the computer requested by a first-level user will not include any second-level files stored on the computer. (Second-level files are not only inaccessible to a first-level user, they are also invisible to a first-level user.) However, a user logging-in with the second-level password may list, obtain information about, operate, and has full access to, all files and operations on the computer (all files and operations, whether such files or operations are identified with the first level or only with the second level). Thus, operations and information (e.g., files) at the second level include all operations and information available at the first level, and further include other operations and information available only at the second level (i.e., to users having possession of the second password).

Methods, devices, and systems according to the present disclosure may include more than two levels. For example, a method, device or system as disclosed herein may have three levels: a first level accessible by a first password; a second level, invisible during operations at the first level, accessible by a second password; and a third level, invisible during operations at the first and second levels, accessible by a third password. An operation or capability is accessible to a user if the user is allowed to command that operation or capability, or to otherwise make use of the operation, capability, or its functionality. Such command or use of an operation, capability, or functionality may be explicit (e.g., a user clicks on an icon, or types a command, or opens a communication link, to initiate or control the operation or make use of the capability) or may be implicit (e.g., a program or communication link may automatically call or initiate a subroutine, DLL, communication protocol, or other operation pursuant to an explicit command by a user).

Operations, capabilities, and information (e.g., files) at the second level include all operations, capabilities, and information available at the first level, and further include other operations, capabilities, and information available only at the second level (i.e., to users having possession of the second password). Operations, capabilities, and information (e.g., files) at the third level include all operations, capabilities, and information available at the first level and at the second level, and further include other operations, capabilities, and information available only at the third level (i.e., to users having possession of the third password).

Note that the use of the terms “first” and “second” and “third” and so forth, with regard to levels and passwords, does not connote any requirement for sequential ordering or use of these passwords; a user of a two-level system or device, having possession of both the first password and the second password, may enter the second password (and obtain access to both the second and first level files and operations of the system or device); or may enter the first password (and obtain access to only the first level files and operations of the system or device). A user of a three-level system or device, having possession of the first password, the second password, and the third password, may enter the third password (and obtain access to and information about all levels—all files and all operations and capabilities of the system or device); may enter the second password (and obtain access to, and information about, both the second and first level files and operations and capabilities of the system or device, but not the third level); or may enter the first password (and obtain access to and information about only the first level files and operations and capabilities of the system or device). Similarly, use of a fourth-level password, or a fifth-level password, or other level password, and so forth, does not require or imply need for sequential use or entry of such passwords; each level password may be used independently of the level of previous or subsequent passwords.

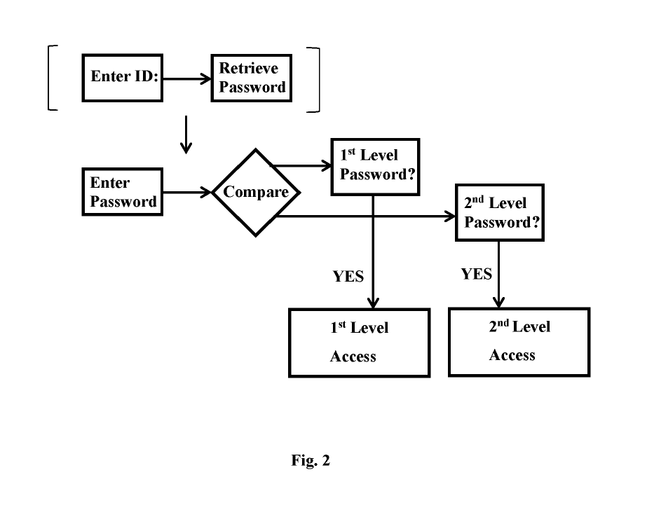

FIG. 2 shows a flow diagram illustrating a system having two levels, a first level accessible by a first password, and a second level, invisible during operations at the first level, accessible by a second password. As indicated in the figure, a user enters a password, which is then compared to stored passwords for determination of whether or not the password is a valid password; optionally (i.e., only in cases where the system requires identification of a particular use), whether or not the password is associated with the identified user; and if valid (and optionally if associated with the identified user), determining the level to which the password provides access. These, and any related actions, are indicated by the diamond labeled “Compare” in the figure. Access is provided to the level allowed by the password entered by a user upon comparison to possible passwords and determination of the allowed level. Access, operations, capabilities, and information (e.g., files) at the second level include all access, operations, capabilities, and information available at the first level, and further include other access, operations, capabilities, and information available only at the second level (i.e., to users having possession of the second password).

In embodiments of the methods, devices, and systems having multiple password-protected levels, a user may enter a password without first being identified (e.g., there may be no requirement that a user enter a username, or identification number, or scan a bar code, or swipe a card, or any other action which would serve to identify the user). Thus, the steps enclosed by brackets in FIG. 2 are not required in such embodiments. In such embodiments, acceptable passwords are stored on the system, or accessible by network or other communications (e.g., by secure and/or encrypted communications link) without being associated with any particular user. The passwords are retrieved from storage (e.g., digital, analog, or any other suitable other storage method or medium) for comparison to the password entered by the user. If the entered password matches the stored password, the user is allowed access at the level associated with the matching password.

However, some embodiments of the methods, devices, and systems having multiple password-protected levels, do require that a user be identified prior to entering a password. In these embodiments, the steps shown within brackets in FIG. 2 are performed. For example, in some embodiments, multiple users may be able to use the device or system, or practice the methods, and each must first be identified in order to determine which passwords are associated with each individual user. Identification of a user may be effected by the user entering a username; or entering an identification number; or scanning a bar code; or swiping a card; or applying a thumb, finger, eye, face, or other body part or region for biometric scanning; or submitting to other electronic imaging or identification; or any other action which serves to identify a user). Upon identification of a particular user, that user's passwords are retrieved from storage (e.g., digital, analog, or any other suitable other storage method or medium) for comparison to the password entered by the user. If the entered password matches the stored password, the user is allowed access at the level associated with the matching password.

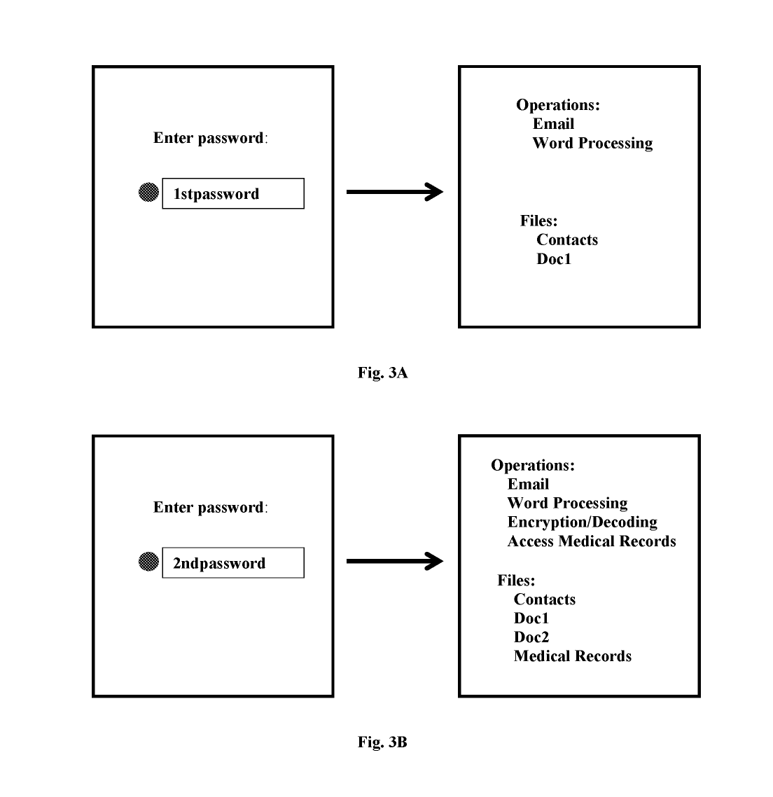

FIGS. 3A and 3B show schematic diagrams of a display on a device configured to provide a user with two levels of access, capability, and operation depending on which of two passwords is entered pursuant to the password entry prompt. No username or user identification is required in this example. FIG. 3A shows entry of a first level password, leading to access and operation at a first level (the arrow pointing right indicating that such access and operation is available to the user after entry of the password shown at the left). Examples of operations and information available at the first level are shown at the right in FIG. 3A. A limited number of operations, and a limited number of files and documents, are available at the first level.

FIG. 3B shows entry of a second level password, leading to access to the capabilities, operations, and information available at a second level (the arrow pointing right indicating that such access and operation is available to the user after entry of the password shown at the left). Examples of operations and information available at the second level are shown at the right in FIG. 3B. In addition to the limited number of operations and files (which were available at the first level), additional operations and files, are accessible at the second level. These additional operations and files are not visible to, nor available to, users at the first level.

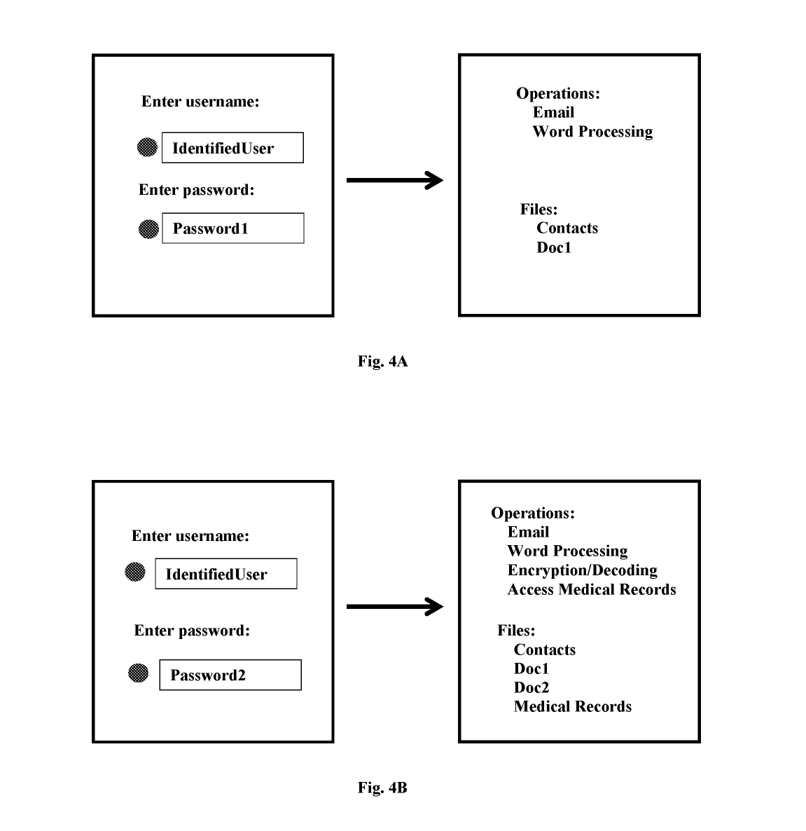

FIGS. 4A and 4B show schematic diagrams of a display on a device configured to provide an identified user with two levels of access and operation depending on which of two passwords is entered pursuant to the password entry prompt. Note that entry of user identification (e.g., a username) determines which passwords will be required for access, with one password providing access to a first level and a second password providing access to a second level. FIG. 4A shows entry of a first level password associated with the identified user, leading to access and operation at a first level (the arrow pointing right indicating that such access to the capabilities, operations, and information is available to the user after entry of the password shown at the left). The limited number of operations and files that are available at the first level are shown in the right of FIG. 4A.

FIG. 4B shows entry of a second level password associated with the same identified user as indicated in FIG. 4A, leading to access and operation at a second level (the arrow pointing right indicating that such access to the capabilities, operation s and information is available to the user after entry of the password shown at the left). In contrast to access at the first level, in addition to all of the limited number of files and documents that are accessible at the first level, further operations and files are accessible to the user at the second level.

It will be understood that a different identified user would be required to enter the particular passwords associated with that user, and would be granted access to the particular first-level and second-level operations and files appropriate for that user only upon entry of the correct passwords. Thus, in the examples illustrated in FIGS. 4A and 4B, if a username other than “IdentifedUser” was entered, then no access would be allowed following entry of either ‘Password1” or “Password2”; these passwords, associated with IdentifiedUser, would not be the correct passwords associated with a different user.

Devices and Systems

A device having a processor may be a computer, a cellphone, a server, or other computing or communications device. A network typically includes devices having a processor.

A server may contain, for example, a processor and memory (e.g., a data storage unit). The processor of a server may be a hardware structure which performs computational operations of a computer program. In embodiments, a processor may carry out instructions stored in a tangible computer-readable medium. The processor may contain one or more microprocessors. Computer memory may include structures for storage of digital information, which typically use volatile storage (e.g. random access memory (RAM)) and/or non-volatile storage (e.g. hard drive). In embodiments, computer memory may use or include non-transitory computer-readable media, which may include, for example, code, logic, or instructions for performing methods provided herein. A server may have any number of processors, and any amount of memory (e.g., any number of data storage units). A server may also contain other components, such as a removable media drive (which may accept, for example, CDs, DVDs, floppy disks, or magnetic tape-based storage), input-output (I/O) channels, buses, network interfaces (wired or wireless structures for facilitating data transfer between a server a network), or power supplies. A server may be a dedicated server, or it may be part of a computer which contains other features (e.g. a monitor, peripherals, etc.). In some embodiments, the server may be part of, for example, a personal computer or a cellphone.

Devices and systems provided herein may contain non-transitory tangible computer-readable media. Computer-readable media can be any available media which can be directly or indirectly accessed by a processor or server of a system provided herein. Computer-readable media may include volatile and nonvolatile media, as well as removable and non-removable media. Computer-readable media may be implemented in any method or technology for storage of information, such as computer-readable instructions, data structures, program modules, or other data. Computer storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage device, or any other medium which can be used to store information and which may be accessed by a processor or server.

A server may be operably connected to one or more external data source (e.g. a website with information of interest, a different server, a computing device, a hard drive, a CD); the server may obtain information from such sources as-needed or at regular intervals. In embodiments, a data source may be a data storage unit operably connected to the server. A server may have load balancing, task management, and backup capacities. The components of a server may be within a single housing unit, or they may be distributed between two or more housing units. A server may be implemented as a distributed network of processors, memory, and storage units. A server may contain or be operably connected to a database (for example, the database may be in a data storage unit of the server or in an external data source). The processor of a server may run a computer program or software, the instructions of which may be provided from, for example, a data storage unit, removable media, or a data storage unit operably connected to the server. In embodiments, two or more servers may act together to function as a server. Servers may communicate with any number and type of computing devices. The server may engage in one-way or two-way communication with computing devices. Other server components or configurations not explicitly discussed herein but known in the art may be included in servers and systems described herein.

A network or system may comprise two or more servers (e.g., a primary serve and a caching server). For example, a primary server may contain or be operably connected one or more databases of information (e.g., a database including patient medial record information, or including bank account information, or other information). For example, a primary server may, with the aid of a processor, use data from a database (or databases) to perform password-protected methods relating to one or more levels of access to information stored in such databases. A caching server may have any of the components or configurations of a server. A caching server is typically optimized for temporary storage of frequently-accessed content from the server, in order to increase the speed at which the content can be delivered to a client/user and to decrease the number of operations required to be performed by the server (and in turn, to increase the performance of the server). For example, a caching server may be configured to regularly update its cached content with data from the server. In embodiments, two or more caching servers may be operably connected to a single server. In other embodiments, two or more caching servers may be operably connected to two or more primary servers. In embodiments, a caching server may be located in a particular geographic area, and may be configured to respond to data requests from users the same or related geographic areas. For example, a first caching server may be located in the eastern United States and used to respond to requests from users located in the eastern United States, and a second caching server could be located in the western United States and used to respond to requests based in the western United States.

A network may be any structure which can support the operable connection of and data transfer between two or more computing devices, such as a local area network (LAN) or a wide area network (WAN), and may include, for example, an intranet, an enterprise private network, the Internet, cellular, or satellite networks. A network may include, for example, one or more of wireless connections, wired connections, or fiber optic connections. Computing devices (e.g. servers, external data sources, and user devices) may connect to the network by wired or wireless technologies. For example, a computing device may connect to the network via wired technologies such as a dial-up connection with a modem, a direct link such as TI, ISDN, cable, Firewire, universal serial bus (USB), or Ethernet wire. In other examples, a computing device may connect to the network via wireless technologies such as Bluetooth, retransmission mode (RTM), infrared (IR), radio frequency (RF), ZigBee, Z-wave, wireless USB, code division multiple access (CDMA) or global system for mobile communications (GSM). In embodiments, data may be encrypted before it is transmitted over the network.

An external data source may be any computing device which may store, transmit, receive, or gather data that may be accessed by or sent to a server of the system. External data sources include, for example, other servers, hard drives (e.g. IDE, ATA, or SATA drives), databases, personal computers, data storage units, hard drives, portable digital media, smartphones (e.g. Apple iPhone, Android-enabled phone), mobile devices, and computer systems, global positioning system (GPS) devices. A client-server relationship, peer-to-peer, or a distributed relationship, may be provided between an external data source and a server of the system. In embodiments, an external data source may communicate directly or indirectly with a server. For example, an external data source may have a direct wired linkage to a server. In another example, an external data source may communicate wirelessly with a server. In another example, an external data source may communicate with a server when an external data source is connected to a personal computer via a wire, and when the personal computer is connected to the Internet. In embodiments, an external data source is operatively coupled to a server. An external data source may be coupled to a server such that data travelling between an external data source and the server passes through a caching server as it travels between an external data source and the server. Alternatively, an external data source may be coupled to a server such that data travelling between an external data source and the server does not pass through a caching server as it travels between an external data source and the server. In embodiments, the system may be configured such that an external data source is operatively coupled to a server without passing through or involving a caching server.

In embodiments, a user may be able to interact with software on a server through a client application running on a device. A client application may be, for example, a World Wide Web (WWW)-based interface. A WWW-based interface may be provided, for example, at a specific URL (e.g. a web page), which users may access via the network through a user device. A user may request a WWW-based interface at a specific URL, and the content may be delivered to the user device from a server (e.g., a primary server or caching server). Delivery of password-protected content may be determined by the password-protected level according to the methods disclosed herein. In embodiments, users may input information on a WWW-based interface, and the information may be provided to a server. In embodiments, a WWW-based interface may permit a user to log in to a user account, using one of a plurality of passwords associated with that user, to permit the user to access to one of a plurality of levels of access to web pages or information associated with the user account.

In addition to the system components and configurations described above and elsewhere herein, it is also noted that other suitable system components and configurations may be used with systems and methods provided herein. For example, embodiments of methods provided herein can be implemented in a computing system that includes a back-end component (e.g. a primary server) and a front-end component (e.g. a user computer having a GUI or Web browser through which a user can interact with a computer software for performing methods provided herein), in which the back-end component and front-end component are interconnected by any combination of hardware and software for digital data communication. In other examples, embodiments of methods provided herein can be implemented using a single computing device (e.g. where the computing device stores relevant data, contains one or more processors for performing operations described herein, receives user information, and displays information to a user).

Sample Analysis Systems Using Multiple Password Levels

An application of the multi-level password methods and systems disclosed herein is in providing results from, and access to, sample analysis devices and systems, such as are used to analyze and provide results from biological samples, for e.g., clinical analysis. For example, a subject may provide a biological sample for analysis for general health parameters and also to determine whether or not the subject suffers from a sexually transmitted disease. In a further example, a subject may provide a biological sample for analysis for general health parameters and also to determine whether or not the sample indicates the use of illegal drugs by the subject. In a further example, a subject may provide a biological sample for analysis for general health parameters and also to determine whether or not the subject is at high risk for a particular cancer, or for a genetic disease, or for a degenerative or dementing disease. In each of these examples, the subject may wish to allow greater access to the results of the analysis for general health parameters than to the results of the other, more specific—and possibly more sensitive—tests. By providing two (or more) levels of password protection, a subject may be able to obtain medical test results while determining which portions of those results may be shared, for example, with family members, an employer, an insurance company, or other third party, and which portion of those results to maintain confidential from those third parties, without those third parties being aware that such other results exist. Thus, the present methods and systems allow an identified user to better control and maintain the confidentiality of information, such as medial test results, than would be available without the present methods and systems.

Sample Analysis Devices, Systems and Methods

The assays and methods disclosed herein may be performed on a device, or on a system, for processing a sample. The assays and methods disclosed herein can be readily incorporated into and used in device for processing a sample, or a system for processing a sample, which may be an automated sample analysis device, or may be an automated sample analysis system (e.g., a system including an automated sample analysis device). Such a device, and such a system, may be useful for the practice of the methods disclosed herein. For example, a device may be useful for receiving a sample. A device may be useful for preparing, or for processing a sample. A device may be useful for performing an assay on a sample. A device may be useful for obtaining data from a sample. A device may be useful for transmitting data obtained from a sample. A device may be useful for disposing of a sample following processing or assaying of a sample.

A device may be part of a system, a component of which may be a sample analysis device. A device may be an automated sample analysis device. A sample analysis device, such as an automated sample analysis device may be configured to facilitate collection of a sample, prepare a sample for a clinical test, or effect a chemical reaction with one or more reagents or other chemical or physical processing, as disclosed herein. A sample analysis device, such as an automated sample analysis device may be configured to obtain data from a sample. A sample analysis device, such as an automated sample analysis device may be configured to transmit data obtained from a sample. A sample analysis device, such as an automated sample analysis device may be configured to analyze data from a sample. A sample analysis device, such as an automated sample analysis device may be configured to communicate with another device, or a laboratory, or an individual affiliated with a laboratory, to analyze data obtained from a sample.

A sample analysis device, such as an automated sample analysis device, may be configured to accept a sample from a subject, either directly or indirectly. A sample may be, for example, a blood sample (e.g., a sample obtained from a fingerstick, or from venipuncture, or an arterial blood sample), a urine sample, a biopsy sample, a tissue slice, stool sample, or other biological sample; a water sample, a soil sample, a food sample, an air sample; or other sample. A blood sample may comprise, e.g., whole blood, plasma, or serum. An automated sample analysis device may receive a sample from the subject through a housing of the device. The sample collection may occur at a sample collection site, or elsewhere. The sample may be provided to the device at a sample collection site.

In some embodiments, a sample analysis device, such as an automated sample analysis device may be configured to accept or hold a cartridge. In some embodiments, a sample analysis device, such as an automated sample analysis device may comprise a cartridge. The cartridge may be removable from the sample analysis device. In some embodiments, a sample may be provided to the cartridge of the sample analysis device. Alternatively, a sample may be provided to another portion of a sample analysis device. The cartridge and/or device may comprise a sample collection unit that may be configured to accept a sample.

A cartridge may include a sample, and may include reagents for use in processing or testing a sample, disposables for use in processing or testing a sample, or other materials. Following placement of a cartridge on, or insertion of a cartridge into, a sample analysis device, such as an automated sample analysis device, one or more components of the cartridge may be brought into fluid communication with other components of the automated sample analysis device. For example, if a sample is collected at a cartridge, the sample may be transferred to other portions of the automated sample analysis device. Similarly, if one or more reagents are provided on a cartridge, the reagents may be transferred to other portions of the sample analysis device, or other components of the sample analysis device may be brought to the reagents. In some embodiments, the reagents or components of a cartridge may remain on-board the cartridge. In some embodiments, no fluidics are included that require tubing or that require maintenance (e.g., manual or automated maintenance).

A sample or reagent may be transferred to a device, such as a sample analysis device. A sample or reagent may be transferred within a device. Such transfer of sample or reagent may be accomplished without providing a continuous fluid pathway from cartridge to device. Such transfer of sample or reagent may be accomplished without providing a continuous fluid pathway within a device. In embodiments, such transfer of sample or reagent may be accomplished by a sample handling system (e.g., a pipette); for example, a sample, reagent, or aliquot thereof may be aspirated into an open-tipped transfer component, such as a pipette tip, which may be operably connected to a sample handling system which transfers the tip, with the sample, reagent, or aliquot thereof contained within the tip, to a location on or within the automated sample analysis device. The sample, reagent, or aliquot thereof can be deposited at a location on or within the automated sample analysis device. Sample and reagent, or multiple reagents, may be mixed using a sample handling system in a similar manner. One or more components of the cartridge may be transferred in an automated fashion to other portions of the automated sample analysis device, and vice versa.

A device, such as a sample analysis device, including an automated sample analysis device, may have a fluid handling system. A fluid handling system may perform, or may aid in performing, transport, dilution, extraction, aliquotting, mixing, and other actions with a fluid, such as a sample. In some embodiments, a fluid handling system may be contained within a device housing. A fluid handling system may permit the collection, delivery, processing and/or transport of a fluid, dissolution of dry reagents, mixing of liquid and/or dry reagents with a liquid, as well as collection, delivery, processing and/or transport of non-fluidic components, samples, or materials. The fluid may be a sample, a reagent, diluent, wash, dye, or any other fluid that may be used by the device, and may include, but not limited to, homogenous fluids, different liquids, emulsions, suspensions, and other fluids. A fluid handling system, including without limitation a pipette, may also be used to transport vessels (with or without fluid contained therein) around the device. The fluid handling system may dispense or aspirate a fluid. The sample may include one or more particulate or solid matter floating within a fluid.

In embodiments, a fluid handling system may comprise a pipette, pipette tip, syringe, capillary, or other component. The fluid handling system may have portion with an interior surface and an exterior surface and an open end. The fluid handling system may comprise a pipette, which may include a pipette body and a pipette nozzle, and may comprise a pipette tip. A pipette tip may or may not be removable from a pipette nozzle. In embodiments, a fluid handling system may use a pipette mated with a pipette tip; a pipette tip may be disposable. A tip may form a fluid-tight seal when mated with a pipette. A pipette tip may be used once, twice, or more times. In embodiments, a fluid handling system may use a pipette or similar device, with or without a pipette tip, to aspirate, dispense, mix, transport, or otherwise handle the fluid. The fluid may be dispensed from the fluid handling system when desired. The fluid may be contained within a pipette tip prior to being dispensed, e.g., from an orifice in the pipette tip. In embodiments, or instances during use, all of the fluid may be dispensed; in other embodiments, or instances during use, a portion of the fluid within a tip may be dispensed. A pipette may selectively aspirate a fluid. The pipette may aspirate a selected amount of fluid. The pipette may be capable of actuating stirring mechanisms to mix the fluid within the tip or within a vessel. The pipette may incorporate tips or vessels creating continuous flow loops for mixing, including of materials or reagents that are in non-liquid form. A pipette tip may also facilitate mixture by metered delivery of multiple fluids simultaneously or in sequence, such as in 2-part substrate reactions.

The fluid handling system may include one or more fluidically isolated or hydraulically independent units. For example, the fluid handling system may include one, two, or more pipette tips. The pipette tips may be configured to accept and confine a fluid. The tips may be fluidically isolated from or hydraulically independent of one another. The fluid contained within each tip may be fluidically isolated or hydraulically independent from one fluids in other tips and from other fluids within the device. The fluidically isolated or hydraulically independent units may be movable relative to other portions of the device and/or one another. The fluidically isolated or hydraulically independent units may be individually movable. A fluid handling system may comprise one or more base or support. A base or support may support one or more pipette or pipette units. A base or support may connect one or more pipettes of the fluid handling system to one another.

A sample analysis device, such as an automated sample analysis device may be configured to perform processing steps or actions on a sample obtained from a subject. Sample processing may include sample preparation, including, e.g., sample dilution, division of a sample into aliquots, extraction, contact with a reagent, filtration, separation, centrifugation, or other preparatory or processing action or step. A sample analysis device, such as an automated sample analysis device may be configured to perform one or more sample preparation action or step on the sample. Optionally, a sample may be prepared for a chemical reaction and/or physical processing step. A sample preparation action or step may include one or more of the following: centrifugation, separation, filtration, dilution, enriching, purification, precipitation, incubation, pipetting, transport, chromatography, cell lysis, cytometry, pulverization, grinding, activation, ultrasonication, micro column processing, processing with magnetic beads, processing with nanoparticles, or other sample preparation action or steps. For example, sample preparation may include one or more step to separate blood into serum and/or particulate fractions, or to separate any other sample into various components. Sample preparation may include one or more step to dilute and/or concentrate a sample, such as a blood sample, or other biological samples. Sample preparation may include adding an anti-coagulant or other ingredients to a sample. Sample preparation may also include purification of a sample. In embodiments, all sample processing, preparation, or assay actions or steps are performed by a single device. In embodiments, all sample processing, preparation, or assay actions or steps are performed within a housing of a single device. In embodiments, most sample processing, preparation, or assay actions or steps are performed by a single device, and may be performed within a housing of a single device. In embodiments, many sample processing, preparation, or assay actions or steps are performed by a single device, and may be performed within a housing of a single device. In embodiments, sample processing, preparation, or assay actions or steps may be performed by more than one device.

A sample analysis device, such as an automated sample analysis device may be configured to run one or more assay on a sample, and to obtain data from the sample. An assay may include one or more physical or chemical treatments, and may include running one or more chemical or physical reactions. A sample analysis device, such as an automated sample analysis device may be configured to perform one, two or more assays on a small sample of bodily fluid. One or more chemical reaction may take place on a sample having a volume, as described elsewhere herein. For example one or more chemical reaction may take place in a pill having less than femtoliter volumes. In an instance, the sample collection unit is configured to receive a volume of the bodily fluid sample equivalent to a single drop or less of blood or interstitial fluid. In embodiments, the volume of a sample may be a small volume, where a small volume may be a volume that is less than about 1000 μL, or less than about 500 μL, or less than about 250 μL, or less than about 150 μL, or less than about 100 μL, or less than about 75 μL, or less than about 50 μL, or less than about 40 μL, or less than about 20 μL, or less than about 10 μL, or other small volume. In embodiments, all sample assay actions or steps are performed on a single sample. In embodiments, all sample assay actions or steps are performed by a single device. In embodiments, all sample assay actions or steps are performed within a housing of a single device. In embodiments, most sample assay actions or steps are performed by a single device, and may be performed within a housing of a single device. In embodiments, many sample assay actions or steps are performed by a single device, and may be performed within a housing of a single device. In embodiments, sample processing, preparation, or assay actions or steps may be performed by more than one device.

A sample analysis device, such as an automated sample analysis device may be configured to perform a plurality of assays on a sample. In embodiments, a sample analysis device may be configured to perform a plurality of assays on a single sample. In embodiments, a sample analysis device may be configured to perform a plurality of assays on a single sample, where the sample is a small sample. For example, a small sample may have a sample volume that is a small volume of less than about 1000 μL, or less than about 500 μL, or less than about 250 μL, or less than about 150 μL, or less than about 100 μL, or less than about 75 μL, or less than about 50 μL, or less than about 40 μL, or less than about 20 μL, or less than about 10 μL, or other small volume. A sample analysis device, such as an automated sample analysis device may be capable of performing multiplexed assays on a single sample. A plurality of assays may be run simultaneously; may be run sequentially; or some assays may be run simultaneously while others are run sequentially. One or more control assays and/or calibrators (e.g., including a configuration with a control of a calibrator for the assay/tests) can also be incorporated into the device; control assays and assay on calibrators may be performed simultaneously with assays performed on a sample, or may be performed before or after assays performed on a sample, or any combination thereof. In embodiments, all sample assay actions or steps are performed by a single device. In embodiments, all of a plurality of assay actions or steps are performed within a housing of a single device. In embodiments, most sample assay actions or steps, of a plurality of assays, are performed by a single device, and may be performed within a housing of a single device. In embodiments, many sample assay actions or steps, of a plurality of assays, are performed by a single device, and may be performed within a housing of a single device. In embodiments, sample processing, preparation, or assay actions or steps may be performed by more than one device.

In embodiments, all of a plurality of assays may be performed in a short time period. In embodiments, such a short time period comprises less than about three hours, or less than about two hours, or less than about one hour, or less than about 40 minutes, or less than about 30 minutes, or less than about 25 minutes, or less than about 20 minutes, or less than about 15 minutes, or less than about 10 minutes, or less than about 5 minutes, or less than about 4 minutes, or less than about 3 minutes, or less than about 2 minutes, or less than about 1 minute, or other short time period.

A sample analysis device, such as an automated sample analysis device may be configured to detect one or more signals relating to the sample. A sample analysis device, such as an automated sample analysis device may be configured to identify one or more properties of the sample. For instance, the sample analysis device may be configured to detect the presence or concentration of one analyte or a plurality of analytes or a disease condition in the sample (e.g., in or through a bodily fluid, secretion, tissue, or other sample). Alternatively, the sample analysis device may be configured to detect a signal or signals that may be analyzed to detect the presence or concentration of one or more analytes (which may be indicative of a disease condition) or a disease condition in the sample. The signals may be analyzed on board the device, or at another location. Running a clinical test may or may not include any analysis or comparison of data collected.

A chemical reaction or other processing step may be performed, with or without the sample. Examples of steps, tests, or assays that may be prepared or run by the device may include, but are not limited to immunoassay, nucleic acid assay, receptor-based assay, cytometric assay, colorimetric assay, enzymatic assay, electrophoretic assay, electrochemical assay, spectroscopic assay, chromatographic assay, microscopic assay, topographic assay, calorimetric assay, turbidmetric assay, agglutination assay, radioisotope assay, viscometric assay, coagulation assay, clotting time assay, protein synthesis assay, histological assay, culture assay, osmolarity assay, and/or other types of assays, centrifugation, separation, filtration, dilution, enriching, purification, precipitation, pulverization, incubation, pipetting, transport, cell lysis, or other sample preparation action or steps, or combinations thereof. Steps, tests, or assays that may be prepared or run by the device may include imaging, including microscopy, cytometry, and other techniques preparing or utilizing images. Steps, tests, or assays that may be prepared or run by the device may further include an assessment of histology, morphology, kinematics, dynamics, and/or state of a sample, which may include such assessment for cells.

A device may be capable of performing all on-board steps (e.g., steps or actions performed by a single device) in a short amount of time. A device may be capable of performing all on-board steps on a single sample in a short amount of time. For example, from sample collection from a subject to transmitting data and/or to analysis may take about 3 hours or less, 2 hours or less, 1 hour or less, 50 minutes or less, 45 minutes or less, 40 minutes or less, 30 minutes or less, 20 minutes or less, 15 minutes or less, 10 minutes or less, 5 minutes or less, 4 minutes or less, 3 minutes or less, 2 minutes or less, or 1 minute or less. The amount of time from accepting a sample within the device to transmitting data and/or to analysis from the device regarding such a sample may depend on the type or number of steps, tests, or assays performed on the sample. The amount of time from accepting a sample within the device to transmitting data and/or to analysis from the device regarding such a sample may take about 3 hours or less, 2 hours or less, 1 hour or less, 50 minutes or less, 45 minutes or less, 40 minutes or less, 30 minutes or less, 20 minutes or less, 15 minutes or less, 10 minutes or less, 5 minutes or less, 4 minutes or less, 3 minutes or less, 2 minutes or less, or 1 minute or less.

A device may be configured to prepare a sample for disposal, or to dispose of a sample, such as a biological sample, following processing or assaying of a sample.

A sample analysis device, such as an automated sample analysis device may be located at a point of service location (POS), and may be configured for use at a POS. A sample analysis device at a POS may be configured to perform a single assay, or a plurality of assays, on samples obtained from a subject. In embodiments, a sample analysis device may be configured to perform a plurality of assays on a single sample. In embodiments, a sample analysis device may be configured to perform a plurality of assays on a single sample, where the sample is a small sample. In embodiments, the sample, or samples, may be obtained at the POS. An identified user may log-in at a first level, or at a second level, or other levels, to an automated sample analysis device located at a POS. Information, including test results, and other information, may be visible to an identified user at a first level, or at a second level, or other levels, logged-in to an automated sample analysis device located at a POS. Information, including test results, and other information, may be accessible to an identified user at a first level, or at a second level, or other levels, logged-in to an automated sample analysis device located at a POS.

In embodiments, a sample analysis device, such as an automated sample analysis device may be configured to transmit data obtained from a sample. In embodiments, a sample analysis device, such as an automated sample analysis device may be configured to communicate over a network. A sample analysis device, such as an automated sample analysis device may include a communication module that may interface with the network. A sample analysis device, such as an automated sample analysis device may be connected to the network via a wired connection or wirelessly. The network may be a local area network (LAN) or a wide area network (WAN) such as the Internet. In some embodiments, the network may be a personal area network. The network may include the cloud. The automated sample analysis device may be connected to the network without requiring an intermediary device, or an intermediary device may be required to connect a sample analysis device to a network. A sample analysis device may communicate over a network with another device, which may be any type of networked device, including but not limited to a personal computer, server computer, or laptop computer; personal digital assistants (PDAs) such as a Windows CE device; phones such as cellular phones, smartphones (e.g., iPhone, Android, Blackberry, etc.), or location-aware portable phones (such as GPS); a roaming device, such as a network-connected roaming device; a wireless device such as a wireless email device or other device capable of communicating wireless with a computer network; or any other type of network device that may communicate possibly over a network and handle electronic transactions. Such communication may include providing data to a cloud computing infrastructure or any other type of data storage infrastructure which may be accessed by other devices.

An identified user may log-in at a first level, or at a second level, or other levels, effective to communicate with an automated sample analysis device, e.g., to communicate via a dedicated communication link, via a network, or in other ways. In embodiments, an identified user may log-in at a first level, or at a second level, or other levels, effective to communicate with an automated sample analysis device located at a POS. Information, including test results, and other information, may be communicated to an identified user, logged-in at a first level, or at a second level, or other levels, via a dedicated communication link, via a network, or in other ways. Such information may be visible to an identified user at a first level, or at a second level, or other levels, logged-in to an automated sample analysis device; in embodiments, the automated sample analysis device may be located at a POS. Information, including test results, and other information, may be accessible to an identified user at a first level, or at a second level, or other levels, logged-in to an automated sample analysis device; in embodiments, the automated sample analysis device located at a POS.

A sample analysis device, such as an automated sample analysis device may provide data regarding a sample to, e.g., a health care professional, a health care professional location, such as a laboratory, or an affiliate thereof. One or more of a laboratory, health care professional, or subject may have a network device able to receive or access data provided by the automated sample analysis device. A sample analysis device, such as an automated sample analysis device may be configured to provide data regarding a sample to a database. A sample analysis device, such as an automated sample analysis device may be configured to provide data regarding a sample to an electronic medical records system, to a laboratory information system, to a laboratory automation system, or other system or software. A sample analysis device, such as an automated sample analysis device may provide data in the form of a report.

A laboratory, device, or other entity or software may perform analysis on data regarding a sample in real-time. A software system may perform chemical analysis and/or pathological analysis, or these could be distributed amongst combinations of lab, clinical, and specialty or expert personnel. Analysis may include qualitative and/or quantitative evaluation of a sample. Data analysis may include a subsequent qualitative and/or quantitative evaluation of a sample. Optionally, a report may be generated based on raw data, pre-processed data, or analyzed data. Such a report may be prepared so as to maintain confidentiality of the data obtained from the sample, the identity and other information regarding the subject from whom a sample was obtained, analysis of the data, and other confidential information. The report and/or the data may be transmitted to a health care professional. Data obtained by an automated sample analysis device, or analysis of such data, or reports, may be provided to a database, an electronic medical records system, to a laboratory information system (LIS), to a laboratory automation system (LAS), or other system or software.

Multiple Password Level Methods Using Sample Analysis Systems

Multiple password level methods, devices and systems may be used in many applications. One exemplary application is in medical testing, including medical diagnostic testing. Such testing typically requires a sample analysis device, or sample analysis system, which may be, e.g., an automated sample analysis device or system. In order to provide test results to a subject, or to a clinician, or to a payer of health care, tests must be ordered, performed, and evaluated; in addition, test results may be stored in a database (e.g., prior to, concurrently with, or after providing test results).

Tests may be ordered for an identified user, where a first group of tests may be ordered when an identified user logs-in with a first password, and a second group of tests may be ordered when the identified user logs-in with a second password. It will be understood that a group of tests may include one, two, three, or more tests, and that the second group of tests may include one or more tests of the first test. Thus, for example, a clinician may order multiple tests for a subject, including tests in a first group and tests in a second group, in such a way that, i) when viewed from a first-level log-in, only a first test, or first group of tests, was ordered for the subject, and ii) when viewed from a second-level log-in, the first group of tests and the second group of tests were ordered for the subject. Thus, for example, a clinician may order tests for a subject in such a way that the fact that the second group of tests were ordered for the subject may remain confidential even when the fact that the first group of tests was ordered is displayed or otherwise made known.

Tests may be performed on a sample obtained from a subject, the tests related to an identified user, where a first group of tests may be related to a first password for the identified user, and a second group of tests may be related to a second password for the identified user. It will be understood that a group of tests may include one, two, three, or more tests, and that the second group of tests may include one or more tests of the first test. Thus, for example, multiple tests may be performed on a sample, or samples, obtained from a subject, including tests in a first group and tests in a second group, and the results of these tests made available in such a way that, i) when viewed from a first-level log-in, only results of the first group of tests are available, and ii) when viewed from a second-level log-in, the results of the second group of tests, or the results of the first group of tests and the second group of tests are available. Thus, for example, the results of tests may be made available in such a way that the fact that the second group of tests was ordered, and the results of those tests, may remain confidential even when the fact that the first group of tests was ordered, and the results of those tests, are displayed or otherwise made known.

The results of tests performed on a sample obtained from a subject may be stored in a database in such a way that some results remain confidential in response to some database queries (e.g., pursuant to a password-protected access to the database using a first-level password), while the results are all accessible in response to other database queries (e.g., pursuant to a password-protected access to the database using a second-level password). For example, the results of tests may be related to an identified user, where the results of a first group of tests may be related to a first password for the identified user, and the results of a second group of tests may be related to a second password for the identified user. It will be understood that a group of tests may include one, two, three, or more tests, and that the second group of tests may include one or more tests of the first test. Thus, for example, the results of multiple tests performed on a sample, or samples, obtained from a subject, may include results of tests in a first group and results of tests in a second group, the results of these tests being stored in a database such that, i) when viewed from a first-level log-in, only results of the first group of tests in the database are available, and ii) when viewed from a second-level log-in, the results of the second group of tests, or the results of the first group of tests and the second group of tests in the database are available. Thus, for example, the database entries may be accessible in such a way that the fact that the second group of tests was ordered, and the results of those tests, may remain confidential even when the fact that the first group of tests was ordered, and the results of those tests, are accessible in the database.

A sample analysis device, including an automated sample analysis device, may be configured so that the results of some tests are only reported to an identified user pursuant to that user logging-in with a first password, while the results of other tests (e.g., additional tests, or a complete listing of tests) are only reported to an identified user pursuant to that user logging-in with a second password. In embodiments, such a sample analysis device may include one or more of (i) a sample collection unit configured to receive the biological sample; (ii) a sample preparation unit configured to prepare the biological sample for the subsequent qualitative and/or quantitative evaluation; and (iii) transmission unit configured to transmit the data to an identified user, clinician, database, or other data recipient; (b) a processor that processes said data for the subsequent qualitative and/or quantitative evaluation of said biological sample. In embodiments, such a sample analysis device may be part of a sample analysis system.

Further sample analysis devices, comprising such a sample analysis device or system, and configured as discussed below are also provided herein. Applicant discloses herein sample analysis devices configured to perform sample analysis tests, wherein an identified user directs the operation of the device, such that the device may be directed to perform two groups of tests on a sample (or samples), one group of tests related to a first password for that identified user, and a second group of tests related to a second password for that identified user. It will be understood that a group of tests may include one, two, three, or more tests, and that the second group of tests may include one or more tests of the first test. In embodiments, the sample analysis device may be configured to communicate the results of these tests to an identified user (e.g., where the communication is an electronic communication), where the results communicated to the identified user are the results of the first group of tests when the identified user logs-in with a first password, and the results communicated to the identified user are the results of the second group of tests when the identified user logs-in with a second password. In embodiments, the sample analysis device may be configured to report the results of these tests to an identified user (e.g., via a lab-report, print-out, display, or other report), where the results reported to the identified user are the results of the first group of tests when the identified user logs-in with a first password, and the results reported to the identified user are the results of the second group of tests when the identified user logs-in with a second password. In embodiments, the sample analysis device may be configured to store the results of these tests in a database accessible to an identified user, where the results in the database accessible to the identified user are the results of the first group of tests when the identified user logs-in with a first password, and the results in the database accessible to the identified user are the results of the second group of tests when the identified user logs-in with a second password.

In embodiments, methods of obtaining sample analysis results; methods of providing test results obtained from a sample; methods of providing results obtained by a sample analysis device; methods of communicating results obtained by a sample analysis device; methods of reporting results obtained by a sample analysis device; methods of storing results obtained by a sample analysis device in a database; and other methods, are provided which utilize a sample analysis device may include one or more of (i) a sample collection unit configured to receive the biological sample; (ii) a sample preparation unit configured to prepare the biological sample for the subsequent qualitative and/or quantitative evaluation; and (iii) transmission unit configured to transmit the data to an identified user, clinician, database, or other data recipient; (b) a processor that processes said data for the subsequent qualitative and/or quantitative evaluation of said biological sample. In embodiments, such a sample analysis device may be part of a sample analysis system.

For example, methods of performing sample analysis include directing a sample analysis device to perform desired tests on a sample (e.g., loading one or more protocols for the desired tests), comprising steps of: providing an identified user, a first password associated with that identified user, and a second password associated with that identified user; directing a sample analysis device to perform a first group of tests, and relating said first group of rests to said first password; and directing a sample analysis device to perform a second group of tests, and relating said second group of rests to said second password; wherein a sample analysis device is directed to perform desired tests on a sample.

Methods of obtaining sample analysis results include directing a sample analysis device to perform desired tests on a sample (e.g., loading one or more protocols for the desired tests), comprising steps of: providing a sample to a sample analysis device; providing an identified user, a first password associated with that identified user, and a second password associated with that identified user; directing a sample analysis device to perform a first group of tests, and relating said first group of rests to said first password; directing a sample analysis device to perform a second group of tests, and relating said second group of rests to said second password; performing the tests on said sample; and obtaining results of said tests, wherein sample analysis results are obtained.

Methods of providing test results obtained from a sample comprise methods of obtaining sample analysis results from a sample, e.g., as discussed above, and further comprising steps of i) providing results of the first group of tests to an identified user pursuant to that user logging-in using a first password, and ii) providing results of the second group of tests to an identified user pursuant to that user logging-in using a second password. Accordingly, a method of providing test results obtained from a sample comprises: providing a sample to a sample analysis device; providing an identified user, a first password associated with that identified user, and a second password associated with that identified user; directing a sample analysis device to perform a first group of tests, and relating said first group of rests to said first password; directing a sample analysis device to perform a second group of tests, and relating said second group of rests to said second password; performing the tests on said sample; obtaining results of said tests; and i) providing results of the first group of tests to an identified user pursuant to that user logging-in using a first password, or ii) providing results of the second group of tests to an identified user pursuant to that user logging-in using a second password, wherein test results are provided. Results of the first group of tests are not provided to a user logging-in using a first password.

Methods of communicating results obtained by a sample analysis device (e.g., where the communication is an electronic communication) comprise methods of obtaining sample analysis results from a sample, e.g., as discussed above, and further comprising steps of i) communicating results of the first group of tests to an identified user pursuant to that user logging-in using a first password, and ii) communicating results of the second group of tests to an identified user pursuant to that user logging-in using a second password. Accordingly, a method of communicating test results obtained from a sample comprises: providing a sample to a sample analysis device; providing an identified user, a first password associated with that identified user, and a second password associated with that identified user; directing a sample analysis device to perform a first group of tests, and relating said first group of rests to said first password; directing a sample analysis device to perform a second group of tests, and relating said second group of rests to said second password; performing the tests on said sample; obtaining results of said tests; and i) communicating results of the first group of tests to an identified user pursuant to that user logging-in using a first password, or ii) communicating results of the second group of tests to an identified user pursuant to that user logging-in using a second password, wherein test results are communicated. Results of the first group of tests are not communicated to a user logging-in using a first password.

Methods of reporting results obtained by a sample analysis device (e.g., via a lab-report, print-out, display, or other report) comprise methods of obtaining sample analysis results from a sample, e.g., as discussed above, and further comprising steps of i) reporting results of the first group of tests to an identified user pursuant to that user logging-in using a first password, and ii) reporting results of the second group of tests to an identified user pursuant to that user logging-in using a second password. Accordingly, a method of reporting test results obtained from a sample comprises: providing a sample to a sample analysis device; providing an identified user, a first password associated with that identified user, and a second password associated with that identified user; directing a sample analysis device to perform a first group of tests, and relating said first group of rests to said first password; directing a sample analysis device to perform a second group of tests, and relating said second group of rests to said second password; performing the tests on said sample; obtaining results of said tests; and i) reporting results of the first group of tests to an identified user pursuant to that user logging-in using a first password, or ii) reporting results of the second group of tests to an identified user pursuant to that user logging-in using a second password, wherein test results are reported. Results of the first group of tests are not reported to a user logging-in using a first password.

Methods of storing results obtained by a sample analysis device in a database comprise methods of obtaining sample analysis results from a sample, e.g., as discussed above, and further comprising steps of storing the results in a database so that i) results of the first group of tests are accessible to an identified user pursuant to that user logging-in using a first password, and ii) results of the second group of tests to an identified user are accessible pursuant to that user logging-in using a second password. Results of the second group of tests are not accessible to a user logging-in with a first password. Accordingly, a method of storing results obtained by a sample analysis device in a database comprises: providing a sample to a sample analysis device; providing an identified user, a first password associated with that identified user, and a second password associated with that identified user; directing a sample analysis device to perform a first group of tests, and relating said first group of rests to said first password; directing a sample analysis device to perform a second group of tests, and relating said second group of rests to said second password; performing the tests on said sample; obtaining results of said tests; and storing the results in a database so that i) results of the first group of tests are accessible to an identified user pursuant to that user logging-in using a first password, and ii) results of the second group of tests to an identified user are accessible pursuant to that user logging-in using a second password, and are not accessible to that user logging-in using a first password.

Accordingly, a sample analysis device, including an automated sample analysis device, may be configured so that the results of some tests are made available to an identified user pursuant to that user logging-in with a first password, while the results of other tests (e.g., additional tests, or a complete listing of tests) are only made available to an identified user pursuant to that user logging-in with a second password. In embodiments of the devices, systems, and methods, further passwords, in addition to a first-level and a second-level password, associated with further levels of confidentiality and security, may be provided.

Accordingly, Applicant discloses methods of providing an identified user password-protected access to a system or device, comprising: providing a first password and a second password, each of said passwords being associated with the same identified user, wherein said first password provides a first level of access to said system or device, and said second password provides a second level of access to said system or device; wherein said second level of access includes access to information, communication, and/or operations unavailable at said first level of access; wherein no indication of the existence of the second level is available or visible at the first level of access; and wherein no indication of, or information regarding, the existence of said information, communication, and/or operations available at said second level is provided to, or available at, the first level of access. In embodiments said information or communication is a lab-report for a test for a disease or condition selected from pregnancy, a genetic disease or condition, a sexually-transmitted disease, a degenerative disease, a dementing disease or condition, and a malignant disease or condition.

Applicant provides methods of communicating a message to an identified user, said message comprising information of a first level of sensitivity, and comprising information of a second level of sensitivity, comprising: providing said identified user with a first password and a second password; providing a system for receiving or accessing said message, wherein said system comprises a plurality of levels, wherein a first level is available to said user when the user provides said first password, and a second level is available to the user when the user provides said second password; providing a version of the message containing only said information of said first level of sensitivity where said user provides said first password; and providing a version of the message containing both said information of said first level of sensitivity and said information of said second level of sensitivity where said user provides said second password. In embodiments, the information or communication is a lab-report for a test for a disease or condition selected from pregnancy, a genetic disease or condition, a sexually-transmitted disease, a degenerative disease, a dementing disease or condition, and a malignant disease or condition. In embodiments of devices configured for the practice of the methods disclosed herein, a lab-report comprises a lab-report for a test for a disease or condition selected from pregnancy, a genetic disease or condition, a sexually-transmitted disease, a degenerative disease, a dementing disease or condition, and a malignant disease or condition.

In embodiments of systems comprising devices configured for the practice of the methods disclosed herein, an identified user creates or chooses one or both of said first password and said second password. In embodiments of systems comprising devices configured for the practice of the methods disclosed herein, one or both of said first password and said second password are assigned to said identified user.

In embodiments, Applicants disclose systems comprising a dedicated link to a central database comprising a processor, the system being configured to operate with a plurality of passwords for a single identified user, wherein a first password provides access to a first level of information, communication, and/or operations, and a second password provides a second level of information, communication, and/or operations, wherein said first and said second level of information, communication, and/or operations are visible or accessible from the second level; and wherein only said first level of information, communication, and/or operations is visible or accessible from the first level. In embodiments of the systems disclosed herein, said dedicated link to a central database comprises a link to a database comprising health-related user records. In embodiments of the systems disclosed herein, such a dedicated link to a central database comprises one or more of a cell-phone link, an internet link, a Wi-Fi link, a link to a health-related message, a link to a lab-report, and a link to a medical record. In embodiments of the systems disclosed herein, a dedicated link to a central database comprises a link to a database comprising a lab-report for a test for a disease or condition selected from pregnancy, an infectious disease, a genetic disease or condition, a sexually-transmitted disease, a degenerative disease, a dementing disease or condition, a malignant disease or condition, an autoimmune disease or condition, a chronic disease or condition, an acute disease or condition, an injury, a childhood disease, and an adult-onset disease.

In embodiments, Applicant discloses methods of communicating to an identified user via a dedicated link to a central database, said link comprising a processor, said communicating comprising providing information of a first level of sensitivity, and comprising providing information of a second level of sensitivity, the method comprising: providing said identified user with a first password and a second password; providing a system comprising a dedicated link to a central database comprising a processor for receiving or accessing said message, wherein said system comprises a plurality of levels, wherein a first level is available to said user when the user provides said first password, and a second level is available to the user when the user provides said second password; and a) providing, via said dedicated link, a version of the message containing only said information of said first level of sensitivity where said user provides said first password; and b) providing, via said dedicated link, a version of the message containing both said information of said first level of sensitivity and said information of said second level of sensitivity where said user provides said second password. In embodiments, such a message comprises information from a medical test, and wherein said information of said second level of sensitivity comprises medical information regarding a disease or condition selected from pregnancy, an infectious disease, a genetic disease or condition, a sexually-transmitted disease, a degenerative disease, a dementing disease or condition, a malignant disease or condition, an autoimmune disease or condition, a chronic disease or condition, an acute disease or condition, an injury, a childhood disease, and an adult-onset disease.

In embodiments, Applicant discloses systems comprising a dedicated link to a sample analysis device comprising a processor, the system being configured to operate with a plurality of passwords for a single identified user, wherein a first password provides access to a first level of information, communication, and/or operations, and a second password provides a second level of information, communication, and/or operations, wherein said first and said second level of information, communication, and/or operations are visible or accessible from the second level; and wherein only said first level of information, communication, and/or operations is visible or accessible from the first level. In embodiments, such a dedicated link to a sample analysis device comprises a computer, a cell-phone, or a tablet computer. In embodiments, such access to information, communication, and/or operations comprises one or more of cell-phone access, internet access, Wi-Fi access, access to an application (e.g., a cellphone “app”), access to an operation, access to a file, access to a database, access to a message, access to a document, access to a lab-report, access to a medical record, access to a photograph, access to an activity log, and access to other information, communications, and operations. In embodiments, such a dedicated link to a sample analysis device comprising a processor is configured to provide a user with a lab-report for a test for a disease or condition selected from pregnancy, an infectious disease, a genetic disease or condition, a sexually-transmitted disease, a degenerative disease, a dementing disease or condition, a malignant disease or condition, an autoimmune disease or condition, a chronic disease or condition, an acute disease or condition, an injury, a childhood disease, and an adult-onset disease.

In embodiments, Applicant discloses methods of communicating a message to an identified user, said message comprising information of a first level of sensitivity, and comprising information of a second level of sensitivity, the method comprising: providing said identified user with a first password and a second password; providing a system comprising a dedicated link to a sample analysis device comprising a processor for receiving or accessing said message, wherein said system comprises a plurality of levels, wherein a first level is available to said user when the user provides said first password, and a second level is available to the user when the user provides said second password; and providing a version of the message containing only said information of said first level of sensitivity where said user provides said first password; and providing a version of the message containing both said information of said first level of sensitivity and said information of said second level of sensitivity where said user provides said second password. In embodiments of such methods, a message may comprise information from a medical test, and wherein said information of said second level of sensitivity comprises medical information regarding a disease or condition selected from pregnancy, an infectious disease, a genetic disease or condition, a sexually-transmitted disease, a degenerative disease, a dementing disease or condition, a malignant disease or condition, an autoimmune disease or condition, a chronic disease or condition, an acute disease or condition, an injury, a childhood disease, and an adult-onset disease.

In embodiments, Applicant discloses systems comprising a sample analysis device comprising a processor, the system being configured to operate with a plurality of passwords for a single identified user, wherein a first password provides access to a first level of information, communication, and/or operations, and a second password provides a second level of information, communication, and/or operations, wherein said first and said second level of information, communication, and/or operations are visible or accessible from the second level; and wherein only said first level of information, communication, and/or operations is visible or accessible from the first level. In embodiments of such systems, a sample analysis device is configured to perform one or more tests on a biological sample obtained from a subject. In embodiments, such a sample analysis device comprises (i) a sample collection unit configured to receive a biological sample obtained from a subject; (ii) a sample preparation unit configured to prepare said biological sample for the subsequent qualitative and/or quantitative evaluation; and (iii) transmission unit configured to transmit the data to an identified user, clinician, database, or other data recipient; (b) a processor that processes said data for the subsequent qualitative and/or quantitative evaluation of said biological sample. In embodiments, such a sample analysis device may be configured to provide a lab-report, wherein said lab-report comprises results of one or more tests performed on one or more biological samples. In embodiments, such a lab-report may include information regarding the results of a test for a disease or condition selected from pregnancy, an infectious disease, a genetic disease or condition, a sexually-transmitted disease, a degenerative disease, a dementing disease or condition, a malignant disease or condition, an autoimmune disease or condition, a chronic disease or condition, an acute disease or condition, an injury, a childhood disease, and an adult-onset disease.

In embodiments, Applicant discloses methods of communicating a message to an identified user, said message comprising information of a first level of sensitivity, and comprising information of a second level of sensitivity, the method comprising: providing said identified user with a first password and a second password; providing a system comprising a sample analysis device, wherein said system is configured to provide a message regarding a result of a test performed by said sample analysis device, wherein said system comprises a plurality of levels, wherein a first level is available to said user when the user provides said first password, and a second level is available to the user when the user provides said second password; and providing a version of the message containing only said information of said first level of sensitivity where said user provides said first password; and providing a version of the message containing both said information of said first level of sensitivity and said information of said second level of sensitivity where said user provides said second password.

In embodiments, Applicant discloses methods of communicating messages, whereins said message comprises information from a medical test, and wherein said information of said second level of sensitivity comprises medical information regarding a disease or condition selected from pregnancy, an infectious disease, a genetic disease or condition, a sexually-transmitted disease, a degenerative disease, a dementing disease or condition, a malignant disease or condition, an autoimmune disease or condition, a chronic disease or condition, an acute disease or condition, an injury, a childhood disease, and an adult-onset disease.

In embodiments, Applicant discloses systems comprising a sample analysis device, the systems being configured to provide a message regarding a result of a test performed by said automated sample analysis device, wherein: said sample analysis device comprises a (i) a sample collection unit configured to receive a biological sample obtained from a subject; (ii) a sample preparation unit configured to prepare said biological sample for the subsequent qualitative and/or quantitative evaluation; and (iii) transmission unit configured to transmit the data to an identified user, clinician, database, or other data recipient; (b) a processor that processes said data for the subsequent qualitative and/or quantitative evaluation of said biological sample, and either comprises, or is operably connected to, a processor configured to process input and output of information and queries between the sample analysis device, an input device, and an output device; and wherein said system further comprises: an input device configured to allow a user to provide information and queries to a processor that is part of, or is operably connected to, said sample analysis device; an output device configured to provide information from said sample analysis device and said processor that is part of, or is operably connected to, the sample analysis device; and a communication link operably connecting said input device, said output device, and said sample analysis device, effective to provide a user with a plurality of levels of access to results of tests performed by said sample analysis device, wherein a first level of access is available to said user when the user provides said first password, and a second level of access is available to the user when the user provides said second password.

Other methods, devices, and systems, including combinations of the methods, devices, and systems discussed above, also utilize multi-level passwords to regulate access to devices, systems, and information provided by such devices and systems. Further examples of methods, devices and systems utilizing multi-level passwords are provided in the Examples below.

### Example 1

The methods, devices and systems disclosed herein are useful for the operation of devices or systems, where a first user is authorized or trained for the use of the device or system at a first level, while a second user is authorized or trained for the use of the device or system at a second level encompassing the first level, and including further capabilities or information unavailable to a first-level user. For example, a database may include information that is available to a first-level user, and also include information not known to be included in the database by the first-level user, and inaccessible to a first-level user, but known to and accessible to a second-level user. Such a database may include financial or business information including clients whose identity is not confidential, and including clients whose identity is confidential.

Such a database may be accessible by a password-protected interface. The information stored in the database may be subject to two-levels of password protection; for example, a user logged-in with a first-level password will be able to see a listing of clients, which does not include the confidential clients, where such listing will appear to be a complete listing. However, a user logged-in with a second-level password will be able to see a complete listing of clients, which includes the confidential clients. In such a case, a user logged-in with a first-level password will be able to see and access financial and other information regarding some clients, but not the confidential clients; such information will appear to be a complete listing of such client information to a first-level user. However, a user logged-in with a second-level password will be able to see and access financial and other information regarding all clients, including the confidential clients.

### Example 2

The methods, devices and systems disclosed herein are useful for the operation of devices or systems, where a user is provided with a card, or tag, or other identifying or enabling device, and where the card, tag, or other identifying device also requires use of a password. In embodiments of the methods, devices and systems disclosed herein, there may be two, or three, or more levels of passwords associated with, or required for, the use of such a card, tag, or other identifying or enabling device. Use of a first level password with the card, tag, or other identifying or enabling device allows a first level of use and access; use of a second level password with the card, tag, or other identifying or enabling device allows a second level of use and access; and so on for further levels, if any. A card, tag, or other identifying or enabling device may be, for example, and without limitation, an automatic teller machine card (ATM card); a credit card; an identity card; a bar code; a quick response code (QR code); a radio-frequency identification device (RFID); a memory stick; a magnetic strip; or other identifying device or system. In the following discussion in this Example, for simplicity, but without limitation, the term “card” will be used to refer to a card, tag, or other identifying or enabling device.

A first user may present a card, and may enter an associated first-level password, in order to access and use a device or system at a first level. Such a first level user will not see displayed, nor receive any information regarding the existence of, nor have any capability to use, information or functionality reserved to the second level. A second user may present a card, and may enter an associated second-level password, in order to access and use a device or system at a second level. Such a second level user will see displayed, and may receive any and all information regarding the existence of, and will be allowed access to, all information and functionality of both the first and the second level. If no third level exists, then a second level user will see displayed, and may receive any and all information regarding the existence of, and will be allowed access to, all information and functionality available on the device or system. If a third level exists, a second level user will remain unaware of, and have no access to, such a third level of the device or system. A third level user, following entry of the third level password, will see displayed, and may receive any and all information regarding the existence of, and will be allowed access to, all information and functionality available on the device or system.

For example, an automatic teller (ATM) method may be, e.g., a method of displaying, accessing, and operating (e.g., making withdrawals, deposits, transfers, and other banking operations) and an ATM machine may be a system or device configured for use in the practice of an ATM method. An ATM system, or device, or method in which an ATM card is read and may be used upon presentation of a password may comprise two levels of operation: a first level, with a first password, in which a limited subset of accounts associated with the ATM card is accessible using the card and the first password; and a second level, with a second password, in which all accounts associated with the ATM card are accessible using the card and the second password. Scenarios in which such a dual-level system may be useful include situations where an ATM card-holder having a plurality of bank accounts (e.g., one or more each of checking, savings, retirement, and other accounts) is forced to use the card to access a bank-account under duress (e.g., during a robbery); in such a situation, the user could use the first-level password, accessing a first account (e.g., a checking account), but leaving all other accounts (e.g., savings, retirement, and other accounts) invisible to a bystander (such as a robber) and so safe from pillage by the robber.

Thus, the existence of a second level, available to a second level user, may be kept confidential while using the device or system. Such a second level of operation may be accessed and used when needed, or desired, but need not be accessed or used when such use is not required, or when such use might reveal information or capabilities that are desired to be kept confidential.

In this example, the second level user had possession of both a first level password, and a second level password. Such a situation may be a typical situation, where a second level user has the ability, and the option, of logging-in at either the first or the second level, depending on the circumstances. As indicated in the present example, circumstances in which a second level user may wish to log in as a first level user include situations where the second level user does not wish others to know of the existence of a second level of use and operation. A further circumstance in which a second level user may wish to log in as a first level user may be one in which information or capability reserved to the second level is not needed at the time the user logs in. A further circumstance in which a second level user may wish to log in as a first level user may be one in which resources may be scarce, and in which information or capability reserved to the second level may require more resources than are available at the time, or than are desired to be used at the time. Such resources may be, for example, memory, power, computing capacity, communication lines, nodes, or other resources.

### Example 3

The methods, devices and systems disclosed herein are useful for the communication of confidential or sensitive communications. Confidential or sensitive communications may be sent to an email account accessible by computer or cellphone, for example. Such an email account may be a password-protected email account. Some or all of a message may be subject to two-levels of password protection; for example, where all of a message is subject to two-levels of password protection, a user logged-in with a first-level password will not receive notification of the arrival of, existence of, or contents of, an email message sent for communication to a second-level user. In such an example a user logged-in with a second-level password will receive notification of the arrival of, will be made aware of the existence of, and will be able to view the contents of, an email message sent for communication to a second-level user. Where only part of a message is subject to two-levels of password protection, a user logged-in with a first-level password will receive the portion of the message available to a first-level user, but will not receive, nor be given indication of the existence of, or contents of, the second-level portion of the email message. In such an example a user logged-in with a second-level password will receive the entire email message sent.

An example of a message available only to a second-level user occurs where a young person has a test for a sexually communicable disease. In such a case, the young person may not wish their parents to know that the test was performed, or the results of the test. The young person may wish to determine whether, or how, or when, to relay any such information to their parents; or may wish to maintain their privacy and keep the information from the parents entirely. In such situations, the young person's cellphone, computer, or email may have two password levels; the parents and the young person are each aware that a password must be entered in order to access email, or text messages, or other communications on the young person's cellphone or computer. The parents and the young person may both know the first level password required to access email, or text messages, or other communications on the young person's cellphone or computer. However, according to the methods, devices and systems disclosed herein, the young person's cellphone or computer may also have a second level password, unknown to the parents, which allows access to all email, or text messages, or other communications on the young person's cellphone or computer. The parents are unaware that such a second-level password, and such a second level of access, exists. The young person, on the other hand, knows that such a second-level password and such a second level of access, exists, and knows the password. A message providing the results of the test for a sexually transmitted disease may be sent to the young person by email, or text messages, or other communication link compatible with a two-level password system or device, and only the young person will be able to see that such a message has arrived, and only the young person will be able to see the contents of the message.

For example, a sender may need only mark an email private, or urgent, or other tag, in order that the receiving device or system know that the message is to be opened only by a second level user. Thus, as present email and text messaging systems include an annotation capability, no special accommodations or alterations are required of the sender, but, in embodiments, present systems may be used to send private messages. In further examples, some information in a report may default to a private, or urgent, setting, so that a report including multiple units of information may report a first, non-sensitive unit of information (e.g., vitamin level in a blood test) while reporting a second, sensitive unit of information (e.g., the result of a test for a sexually transmitted disease) only as private, or urgent, information accessible to only a user logged-in with a second or higher-level password. In such a scenario, a first level user would not be aware that such a test was even performed, not would a first level user be able to access the results.

A similar example may be seen where a message includes a portion available to a first-level user, and a portion available only to a second-level user. For example, a young person may have a battery of medical tests, where the battery includes a test for a sexually communicable disease. In such a case, the young person may not wish their parents to know that the test was performed, or the results of the test, but may have no desire to withhold the results of the other tests in the battery of tests. In such a situation, the young person's cellphone, computer, or email may have two password levels; the parents and the young person are each aware that a password must be entered in order to access email, or text messages, or other communications on the young person's cellphone or computer. The parents and the young person may both know the first level password required to access email, or text messages, or other communications on the young person's cellphone or computer. However, according to the methods, devices and systems disclosed herein, the young person's cellphone or computer may also have a second level password, unknown to the parents, which allows access to all email, or text messages, or other communications on the young person's cellphone or computer. A message may be sent to the young person providing the results of the battery of tests, including the results for the test for a sexually transmitted disease as well as the results of the other tests. Such a message may be sent to the young person by email, or text messages, or other communication link compatible with both password levels. In this case, the results of the other tests will be available to a first level user (e.g., the parents) while only the young person will be able to see that a test for a sexually transmitted disease was also given, and only the young person will be able to see the results of the test for the sexually transmitted disease.

Similar examples may be seen where, for example, a young woman has a pregnancy test, yet may not want parents or others to know the test was given, or the results of the test; or where a paternity test is given, where the person does not want a spouse or child to know either that the test was given, or the results, or both. A further example occurs where a person has been tested for the presence of drugs, and does not wish a spouse, or an employer, or other person to receive the results, or does not wish another to receive the results before the tested person. A further example occurs where a person has been tested for a serious disease, or a progressive disease, or an incurable disease, or a debilitating disease, such as, e.g., a cancer, multiple sclerosis, Lyme disease, or other disease, and does not wish others to know that such a test was performed or the results of the test, or both. A further example occurs where a person has been tested for a psychological or mental condition or disorder (e.g., depression, bipolar disorder, or other disorder), and does not wish others to know that such a test was performed or the results of the test, or both. A further example occurs where a person has been tested for a learning difference (e.g., attention deficit disorder), and does not wish others to know that such a test was performed or the results of the test, or both.

Further examples of multiple-level methods, systems, and devices where communications may be sent in which some, or all, of a communication may be invisible to, and inaccessible to, a lower level user while being visible and available to a higher level user include communications from a bank or other financial institution, allowing a higher level user to maintain privacy or secrecy about their financial affairs; legal communications between clients and attorneys, or between opposing counsel, regarding legal strategies, evidence, and other legal matters, allowing users to maintain proper levels of confidentiality and privilege; engineering and scientific communications between collaborators and contractors or others, allowing collaborators to communicate at one level while maintaining confidentiality with others who may not need to have access to all parts, or all of, such communications; business communications between internal and external partners (e.g., of a joint business venture in which not all communicants work for the same employers); and other situations where a communication may need to be, or may be wished to be, kept confidential, or where a portion of a communication may need to be, or may be wished to be, kept confidential.

Thus, the methods, devices, and systems disclosed herein allow a second level user to maintain a desired level of privacy, while also maintaining the ease of allowing others access to information or operations accessible to first level users. As discussed, with regard to medical or other tests, a person may not wish others to know that the test was given; or the results; or both. A person may wish to know the results of the test, and then to decide whether or not to communicate those results to others. A person may wish to know the results of the test, and then to decide how best to communicate those results to others. A person may wish to know the results of the test, and then to decide to whom to communicate the results. The multi-level devices, systems and methods disclosed herein provide such a person the means to receive and review such results at a second level (which is inaccessible to a first-level user) without others, including those who may have first level access to a device or system receiving such a report, being able to review or even become aware of the existence of such information.

For example, a person wishing to know the results of the test, or to receive any other information or communication, in confidence, may have an email system which provides two (or more) level access. A healthcare provider may provide patients with an on-line interface (e.g., a web-page) to which patients may log-in to receive medical information, where the on-line interface has two (or more) passwords, so that some test results or medical information are available to users logging in with a first password, but other test results or medical information are available only to users logging in with a second (or higher level) password. A bank or financial institution may provide customers with an on-line interface (e.g., a web-page) to which customers may log-in to receive account information, where the on-line interface has two (or more) passwords, so that some accounts or account information are available to users logging in with a first password, but other accounts or account information are available only to users logging in with a second (or higher level) password.

### Example 4

The methods, devices and systems disclosed herein may be used, for example, in social media, where a user has a social media page, and may log-in as the user using a first password. The user may allow others (e.g., parents, or friends, or co-workers) access to the social media page via a first level password. However, the user may also have a second-level, and may also have third-level or higher, passwords, in which some social media information (posts, contacts, activities, links, or other information) remains inaccessible to the others having only a first-level password, yet remains available to the user when the user logs in with a second (or higher) level password.

Thus, the methods, devices, and systems disclosed herein allow a second level user to maintain a desired level of confidentiality or secrecy, while also maintaining the ease of allowing others access to information or operations accessible to first level users. As discussed, with regard to legal, scientific, engineering, business, and other communications, a person or group of persons may wish to keep a portion of the existence of a communication confidential and unknown to others, or may wish to keep a portion of a communication confidential and unknown to others.

While the invention has been described and illustrated with reference to certain particular embodiments thereof, those skilled in the art will appreciate that various adaptations, changes, modifications, substitutions, deletions, or additions of procedures and protocols may be made without departing from the spirit and scope of the invention. For example, with any of the above embodiments, it should be understood that the password usage herein is not limited to healthcare settings (e.g., medical settings) and banking settings, but can find application in any setting where a password is used to regulate access to a device or system, including, but not limited to, healthcare (e.g., medical); banking or finance; commerce (e.g., payments by individuals, or by businesses, governmental agencies, or other entities, for purchase of goods or services, whether recurring payments or irregular or unique payments); messaging (e.g., text, voice, or other messaging) using a cellphone, computer, or other device; computing; social networks; and other settings.

The publications discussed or cited herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed. All publications mentioned herein are incorporated herein by reference to disclose and describe the structures and/or methods in connection with which the publications are cited.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. Any feature, whether preferred or not, may be combined with any other feature, whether preferred or not. The appended claims are not to be interpreted as including means-plus-function limitations, unless such a limitation is explicitly recited in a given claim using the phrase “means for.” It should be understood that as used in the description herein and throughout the claims that follow, the meaning of “a,” “an,” and “the” includes plural reference unless the context clearly dictates otherwise. For example, a reference to “an assay” may refer to a single assay or multiple assays. Also, as used in the description herein and throughout the claims that follow, the meaning of “in” includes “in” and “on” unless the context clearly dictates otherwise. Finally, as used in the description herein and throughout the claims that follow, the meaning of “or” includes both the conjunctive and disjunctive unless the context expressly dictates otherwise. Thus, the term “or” includes “and/or” unless the context expressly dictates otherwise.

### COPYRIGHT

This document contains material subject to copyright protection. The copyright owner (Applicant herein) has no objection to facsimile reproduction of the patent documents and disclosures, as they appear in the US Patent and Trademark Office patent file or records, but otherwise reserves all copyright rights whatsoever. The following notice shall apply: Copyright 2013-2104 Thermos, Inc.

1-9. (canceled)

10. A device comprising a processor configured to operate with a plurality of passwords for a single identified user, wherein a first password provides access to a first level of information, communication, and/or operations, and a second password provides a second level of information, communication, and/or operations, wherein said first and said second level of information, communication, and/or operations are visible or accessible from the second level; and wherein only said first level of information, communication, and/or operations is visible or accessible from the first level.

11. The device of claim 10, wherein said device comprises a computer, a cell-phone, a tablet computer, a dedicated link to a central database, a dedicated link to a sample analysis device, a dedicated link to an automated sample analysis device, a sample analysis device, or an automated sample analysis device.

12. The device of claim 10, wherein said access to information, communication, and/or operations comprises one or more of cell-phone access, internet access, Wi-Fi access, access to an application (e.g., a cellphone “app”), access to an operation, access to a file, access to a database, access to a message, access to a document, access to a lab-report, access to a medical record, access to a photograph, access to an activity log, access to a bank account, access to a brokerage account, access to a financial record, access to a bill, access to a location tracking device, and access to other information, communications, and operations.

13. The device of claim 10, wherein said message is selected from an email message, a voicemail message, a real-time message, a stored message, and other messages.

14. The device of claim 10, wherein said lab-report comprises a lab-report for a test for a disease or condition selected from pregnancy, an infectious disease, a genetic disease or condition, a sexually-transmitted disease, a degenerative disease, a dementing disease or condition, a malignant disease or condition, an autoimmune disease or condition, a chronic disease or condition, an acute disease or condition, an injury, a childhood disease, and an adult-onset disease.

15. A system comprising a sample analysis device comprising a processor, the system being configured to operate with a plurality of passwords for a single identified user, wherein a first password provides access to a first level of information, communication, and/or operations, and a second password provides a second level of information, communication, and/or operations, wherein said first and said second level of information, communication, and/or operations are visible or accessible from the second level; and wherein only said first level of information, communication, and/or operations is visible or accessible from the first level.

16. The system of claim 15, wherein said device comprises a computer, a cell-phone, a tablet computer, a dedicated link to a central database, a dedicated link to a sample analysis device, a dedicated link to an automated sample analysis device, a sample analysis device, or an automated sample analysis device.

17. The system of claim 15, wherein said access to information, communication, and/or operations comprises one or more of cell-phone access, internet access, Wi-Fi access, access to an application (e.g., a cellphone “app”), access to an operation, access to a file, access to a database, access to a message, access to a document, access to a lab-report, access to a medical record, access to a photograph, access to an activity log, access to a bank account, access to a brokerage account, access to a financial record, access to a bill, access to a location tracking device, and access to other information, communications, and operations.

18. The system of claim 15, wherein said message is selected from an email message, a voicemail message, a real-time message, a stored message, and other messages.

19. The system of claim 15, wherein said lab-report comprises a lab-report for a test for a disease or condition selected from pregnancy, an infectious disease, a genetic disease or condition, a sexually-transmitted disease, a degenerative disease, a dementing disease or condition, a malignant disease or condition, an autoimmune disease or condition, a chronic disease or condition, an acute disease or condition, an injury, a childhood disease, and an adult-onset disease.

20-31. (canceled)

32. The device of claim 10, wherein said lab-report comprises a lab-report for a test for a disease or condition selected from pregnancy, a genetic disease or condition, a sexually-transmitted disease, a degenerative disease, a dementing disease or condition, and a malignant disease or condition.

33. The system of claim 15, wherein said lab-report comprises a lab-report for a test for a disease or condition selected from pregnancy, a genetic disease or condition, a sexually-transmitted disease, a degenerative disease, a dementing disease or condition, and a malignant disease or condition.

34-48. (canceled)

49. The system of claim 15, wherein said sample analysis device is configured to perform one or more tests on a biological sample obtained from a subject.

50. The system of claim 15, wherein said sample analysis device comprises (i) a sample collection unit configured to receive a biological sample obtained from a subject; (ii) a sample preparation unit configured to prepare said biological sample for the subsequent qualitative and/or quantitative evaluation; and (iii) transmission unit configured to transmit the data to an identified user, clinician, database, or other data recipient; (b) a processor that processes said data for the subsequent qualitative and/or quantitative evaluation of said biological sample.

51. The system of claim 15, wherein said sample analysis device is configured to provide a lab-report, wherein said lab-report comprises results of one or more tests performed on one or more biological samples.

52. The system of claim 51, wherein said lab-report comprises a lab-report for a test for a disease or condition selected from pregnancy, an infectious disease, a genetic disease or condition, a sexually-transmitted disease, a degenerative disease, a dementing disease or condition, a malignant disease or condition, an autoimmune disease or condition, a chronic disease or condition, an acute disease or condition, an injury, a childhood disease, and an adult-onset disease.

53-54. (canceled)

55. A system comprising a sample analysis device, wherein said system is configured to provide a message regarding a result of a test performed by said sample analysis device, wherein:
said sample analysis device comprises a (i) a sample collection unit configured to receive a biological sample obtained from a subject; (ii) a sample preparation unit configured to prepare said biological sample for the subsequent qualitative and/or quantitative evaluation; and (iii) transmission unit configured to transmit the data to an identified user, clinician, database, or other data recipient; (iv) a processor that processes said data for the subsequent qualitative and/or quantitative evaluation of said biological sample, and either comprises, or is operably connected to, a processor configured to process input and output of information and queries between the sample analysis device, an input device, and an output device;
And wherein said system further comprises:
an input device configured to allow a user to provide information and queries to a processor that is part of, or is operably connected to, said sample analysis device;
an output device configured to provide information from said sample analysis device and said processor that is part of, or is operably connected to, the sample analysis device; and
a communication link operably connecting said input device, said output device, and said sample analysis device, effective to provide a user with a plurality of levels of access to results of tests performed by said sample analysis device, wherein a first level of access is available to said user when the user provides said first password, and a second level of access is available to the user when the user provides said second password.

56. The system of claim 55, wherein said processor of sample analysis device is configured to provide results to identified user pursuant to receiving a password associated with said identified user, wherein: 1) the results of a first group of tests are provided pursuant to that user logging-in with a first password, and 2) the results of a second group of tests are only provided pursuant to that user logging-in with a second password.

57. The system of claim 56, wherein said second group of tests comprises one or more of the tests of said first group of tests.

58. The system of claim 56, wherein providing is selected form the group of communicating, reporting, displaying, and storing in a database.

59-71. (canceled)
